(19) United States
(12) Patent Application Publication
(10) Pub. No.: US 2025/0001574 A1
(43) Pub. Date: Jan. 2, 2025

(54) Housing Device for a Hand-Held Power Tool, and Hand-Held Power Tool Having the Housing Device

(71) Applicant: Robert Bosch GmbH, Stuttgart (DE)

(72) Inventors: Andreas Wolf, Stuttgart (DE); Thomas Bernhardt, Aichtal (DE); Sinisa Andrasic, Schoenaich (DE); Adrian Karcher, Stuttgart (DE); Marie Theresa Preusser, Karlsruhe (DE); Manfred Lutz, Filderstadt (DE); Vincent Hasenmayer, Stuttgart (DE)

(21) Appl. No.: 18/700,229

(22) PCT Filed: Oct. 11, 2022
(86) PCT No.: PCT/EP2022/078221

§ 371 Date: Apr. 10, 2024

(30) Foreign Application Priority Data
Oct. 22, 2021 (DE) 10 2021 211 952.2

(51) Int. Cl. B25F 5/02; B24B 23/02; B25F 5/00

(52) U.S. Cl. CPC B25F 5/026; B24B 23/028; B25F 5/001

(57) ABSTRACT

The disclosure relates to a housing apparatus, in particular a hand-held power tool housing, for a hand-held power tool, in particular an angle grinder, with at least one handle housing which comprises at least one bow handle, with at least one motor housing which comprises a storage area in which a drive unit of the hand-held power tool can be disposed and which specifies an orientation of an axis of rotation of the drive unit, wherein, viewed in a direction parallel to the axis of rotation, the handle housing, in particular the bow handle, is disposed on the motor housing at least substantially entirely on a side of the motor housing facing away from a gearbox housing connection region of the motor housing, and with at least one battery pack interface for placement of at least one battery pack which is disposed on the handle housing on a side of the handle housing facing away from the bow handle.

It is proposed that, viewed along a direction perpendicular to the axis of rotation, the bow handle projects largely beyond the motor housing.

### PRIOR ART

A housing apparatus for a hand-held power tool with at least one handle housing which comprises at least one bow handle, with at least one motor housing which comprises a storage area in which a drive unit of the hand-held power tool can be disposed and which specifies an orientation of an axis of rotation of the drive unit, wherein, viewed in a direction parallel to the axis of rotation, the handle housing is disposed on the motor housing at least substantially entirely on a side of the motor housing facing away from a gearbox housing connection region of the motor housing, and with at least one battery pack interface for placement of at least one battery pack, which is disposed on the handle housing on a side of the handle housing facing away from the bow handle, is already known from DE 11 2013 006 566 B4.

### DISCLOSURE OF THE INVENTION

The invention relates to a housing apparatus, in particular a hand-held power tool housing, for a hand-held power tool, in particular for an angle grinder, with at least one handle housing which comprises at least one bow handle, with at least one motor housing which comprises a storage area in which a drive unit of the hand-held power tool can be disposed and which specifies an orientation of an axis of rotation of the drive unit, and with at least one battery pack interface for placement of at least one battery pack, which is disposed on the handle housing on a side of the handle housing facing away from the bow handle.

Viewed in a direction parallel to the axis of rotation, the handle housing, in particular the bow handle, is preferably disposed on the motor housing at least substantially entirely on a side of the motor housing facing away from a gearbox housing connection region of the motor housing.

It is proposed that, viewed along a direction perpendicular to the axis of rotation, the bow handle projects largely beyond the motor housing. “Largely” can be understood to mean at least 50% and preferably at least 75% of a total volume of an object. At least viewed along the direction perpendicular to the axis of rotation, in particular at least 50% of a total volume of the bow handle, preferably at least 75% of the total volume of the bow handle, extends beyond the motor housing. The bow handle preferably comprises at least one gripping surface, which preferably faces the handle housing, in particular the handle housing base body, and is provided for holding the bow handle, in particular with a hand of the user, when the housing apparatus is being carried by a user and/or when a user is working with a hand-held power tool comprising the housing apparatus. A spacing of the gripping surface of the bow handle, which preferably faces the handle housing, in particular the handle housing base body, relative to the axis of rotation along an axis perpendicular to the axis of rotation is preferably at least partly greater than a maximum extension of the motor housing starting from the axis of rotation along the direction perpendicular to the axis of rotation. Viewed along the direction perpendicular to the axis of rotation, the spacing of the gripping surface of the bow handle relative to the axis of rotation preferably extends, viewed along the direction perpendicular to the axis of rotation, from the axis of rotation to a surface of the gripping surface of the bow handle facing the axis of rotation. Viewed along the direction perpendicular to the axis of rotation, the maximum extension of the motor housing starting from the axis of rotation extends in particular from the axis of rotation to a point of a surface of the motor housing furthest away from the axis of rotation viewed along the direction perpendicular to the axis of rotation. The bow handle preferably comprises at least one control element, which is provided for opening or closing a circuit for influencing a current supply to the drive unit of the hand-held power tool, for example. Viewed along the direction perpendicular to the axis of rotation, the at least one control element is preferably disposed spaced apart from the motor housing in particular on a side of the handle housing facing away from the battery pack interface.

The battery pack interface is provided in particular to accommodate one battery pack or a plurality of, preferably at least two, battery packs. The battery pack interface is preferably provided for electrically and mechanically contacting the at least one or the plurality of battery packs. The battery pack interface in particular comprises at least electrical and/or mechanical contact elements for contacting the at least one battery pack or the plurality of battery packs. The battery pack interface is preferably configured such that an insertion direction of the at least one battery pack or the plurality of battery packs for placement on the battery pack interface extends at least substantially perpendicular to the axis of rotation. The insertion direction is in particular at least substantially perpendicular to a main extension plane of the bow handle. Alternatively, it is also conceivable that the insertion direction extends at least substantially parallel to the main extension plane of the bow handle, in particular at least substantially parallel or at least substantially perpendicular to the axis of rotation. It is furthermore alternatively also conceivable that the insertion direction is angled, in particular other than perpendicular, to the main extension plane of the bow handle. A “main extension plane” of a structural unit or an element can in particular be understood to be a plane which is parallel to a largest side surface of a smallest possible notional cuboid which just completely encloses the structural unit, and in particular extends through the midpoint of the cuboid. The axis of rotation preferably extends in the main extension plane of the bow handle. One 36 V battery pack or two 18 V battery packs can be disposed on the battery pack interface, for example. It is conceivable that the battery packs which can be disposed on the battery pack interface differ at least in terms of battery capacity. The at least one battery pack preferably has a battery capacity between 1 Ah and 15 Ah, preferably between 2 Ah and 12 Ah. However, other battery capacities and/or battery voltages of the battery pack deemed appropriate by those skilled in the art are alternatively conceivable as well. The at least one battery pack comprises a single battery cell layer, for instance, which is in particular formed by a battery cell embodied in flat construction or by a plurality of cylindrical battery cells. It is also conceivable that the at least one battery pack comprises at least two battery cell layers, which are respectively formed by a battery cell embodied in flat construction or by a plurality of cylindrical battery cells. The drive unit in particular comprises at least one electric motor for driving an output spindle of the hand-held power tool. The axis of rotation of the drive unit preferably extends at least substantially parallel to a main extension axis of the hand-held power tool. A “main extension axis” of an object can in particular be understood to mean an axis which extends parallel to a longest edge of a smallest geometrical cuboid which just completely encloses the object. “Substantially parallel” can be understood here to mean an orientation of a direction relative to a reference direction, in particular in a plane, wherein the direction has a deviation relative to the reference direction that is in particular less than 8°, advantageously less than 5° and particularly advantageously less than 2°.

The handle housing preferably comprises a handle housing base body on which the bow handle is disposed. The handle housing base body is preferably disposed on the motor housing. The handle housing, in particular the handle housing base body, is preferably movably mounted on the motor housing, preferably mounted on the motor housing such that it can be rotated relative to the motor housing by means of a pivot joint of the housing apparatus. The handle housing is in particular mounted on the motor housing such that it can be rotated by means of the pivot joint, preferably about a rotary axis of the pivot joint. The rotary axis in particular extends at least substantially parallel to the axis of rotation. The rotary axis particularly preferably corresponds to the axis of rotation. Alternatively, however, it is also conceivable that the rotary axis extends at an angle to the axis of rotation. The bow handle is disposed at least substantially entirely on a side of the motor housing facing away from a gearbox housing connection region of the motor housing, in particular on the handle housing base body. “Substantially entirely” can be understood to mean at least 50%, preferably at least 75% and preferably at least 90% of a total volume of an object. Most particularly preferably, the handle housing, in particular the bow handle, is disposed entirely on the side of the motor housing facing away from the gearbox housing connection region of the motor housing. In particular 100% of a total volume of the handle housing, in particular the bow handle, is disposed on the side of the motor housing facing away from the gearbox housing connection region of the motor housing. The housing apparatus in particular comprises at least one gearbox housing. The gearbox housing is preferably disposed on the motor housing, in particular on a side of the motor housing facing away from the handle housing. The output spindle is preferably disposed on the gearbox housing, in particular mounted in the gearbox housing. An output axis of the output spindle is preferably defined by the gearbox housing. The output spindle is preferably mounted in the gearbox housing such that it can rotate about the output axis. The output axis in particular extends at least substantially perpendicular to the axis of rotation and/or the main extension axis of the hand-held power tool. “Substantially perpendicular” can be understood to mean an orientation of a direction relative to a reference direction, wherein, in particular viewed in a projection plane, the direction and the reference direction enclose an angle of 90° and the angle has a maximum deviation of in particular less than 8°, advantageously less than 5° and particularly advantageously less than 2°.

In particular viewed along the direction perpendicular to the axis of rotation, the motor housing has a maximum extension between 50 mm and 100 mm, preferably between 70 mm and 80 mm and particularly preferably 75 mm. A perimeter of the motor housing, which in particular extends in a plane perpendicular to the axis of rotation, is in particular between 280 mm and 310 mm, preferably between 285 mm and 295 mm and particularly preferably 292 mm. The housing apparatus in particular comprises at least one mounting interface for attaching an auxiliary handle of the hand-held power tool or a hand-held power tool system, which preferably comprises the hand-held power tool. The mounting interface is preferably disposed on the gearbox housing. It is alternatively also conceivable that the mounting interface is disposed on the motor housing or another component of the housing apparatus. The mounting interface is configured as a thread, for example, in particular as an external thread or as an internal thread. It is furthermore also conceivable that the auxiliary handle can be attached to the housing apparatus, in particular the gearbox housing, by means of straps, a clamp or the like. The mounting interface preferably defines an orientation of a main extension axis of the auxiliary handle. In a state of the auxiliary handle in which it is disposed on the housing apparatus, in particular on the gearbox housing, the main extension axis of the auxiliary handle preferably extends at least substantially perpendicular to the axis of rotation and/or the output axis. A spacing between the mounting interface or a midpoint of a free end of the auxiliary handle disposed on the mounting interface to a midpoint of the bow handle, in particular viewed along the direction parallel to the axis of rotation, is preferably between 310 mm and 360 mm, preferably between 330 mm and 340 mm and particularly preferably 335 mm. The midpoint of the bow handle is preferably disposed on a central fiber of the bow handle in the middle of a maximum longitudinal extension of the bow handle along the central fiber. A central fiber of an object, in particular the central fiber of the bow handle, preferably extends over an entire maximum longitudinal extension of the object, in particular the entire maximum longitudinal extension of the bow handle, through cross-sectional midpoints of the object, in particular the bow handle. The cross-sectional midpoints of the object, in particular the bow handle, are preferably respectively formed by a midpoint, in particular a geometric center of gravity of a cross-sectional area of the object, in particular the bow handle. The respective cross-sectional area of the object, in particular the bow handle, preferably extends in a plane that is perpendicular to a main extension plane of the object, in particular the bow handle. The respective cross-sectional area of the object, in particular the bow handle, particularly preferably extends at least substantially perpendicular to an outer wall of the object, in particular the bow handle, which delimits the respective cross-sectional area. A course of the central fiber of the object, in particular the bow handle, is preferably defined by a shape of the object, in particular the bow handle, viewed along the maximum longitudinal extension of the object, in particular the bow handle. Viewed along the direction parallel to the axis of rotation, a minimum spacing between the output axis of the output spindle and the motor housing, in particular a gearbox connection point of the motor housing, is preferably between 35 mm and 65 mm, preferably between 40 mm and 60 mm and particularly preferably 50 mm. Alternatively, however, it is also conceivable that the housing apparatus has other dimensions, in particular depending on a maximum longitudinal extension of the housing apparatus.

The configuration according to the invention makes it possible to provide a housing apparatus that can enable particularly comfortable grip ergonomics for a user. Advantageously, a particularly large spacing of a gripping region of the bow handle to a workpiece contact point when machining a workpiece can be achieved. This advantageously makes it possible to achieve a particularly high level of protection for a user against removed material created when machining a workpiece. A particularly large safety distance to the tool spindle can thus advantageously be realized. The special arrangement of the bow handle advantageously makes it possible to realize a particularly large lever relative to the rotary axis of the pivot joint. This can advantageously achieve a particularly smooth rotation of the handle housing relative to the motor housing.

It is further proposed that, at least viewed along the direction perpendicular to the axis of rotation, a maximum spacing of the bow handle relative to the axis of rotation is at least 80 mm. In an alternative embodiment, it is conceivable that the housing apparatus is configured independently of the fact that, viewed along the direction perpendicular to the axis of rotation, the bow handle projects largely beyond the motor housing. In the alternative configuration, in particular in the configuration that is independent of fact that, viewed along the direction perpendicular to the axis of rotation, the bow handle projects largely beyond the motor housing, the housing apparatus preferably comprises at least the handle housing which comprises at least the bow handle, at least the motor housing which comprises the storage area in which the drive unit of the hand-held power tool can be disposed and which specifies an orientation of the axis of rotation of the drive unit, wherein the handle housing in particular the bow handle, is disposed on the motor housing on the side of the motor housing facing away from the gearbox housing connection region of the motor housing, and at least the battery pack interface for placement of the at least one battery pack, which is disposed on the handle housing on the side of the handle housing facing away from the bow handle, wherein a maximum spacing of the bow handle relative to the axis of rotation is at least 80 mm at least viewed along the direction perpendicular to the axis of rotation. The maximum spacing of the bow handle relative to the axis of rotation viewed along the direction perpendicular to the axis of rotation preferably extends from a gripping surface of the bow handle facing away from the handle housing, in particular the handle housing base body, which, viewed along the perpendicular to the axis of rotation, is preferably the furthest away from the axis of rotation. The maximum spacing of the bow handle relative to the axis of rotation, at least viewed along the direction perpendicular to the axis of rotation, is at least 90 mm, preferably at least 100 mm and particularly preferably at least 110 mm. The maximum spacing of the bow handle relative to the axis of rotation, in particular viewed along the direction perpendicular to the axis of rotation, is preferably at most 200 mm, preferably at most 150 mm and particularly preferably at most 130 mm. A value of the maximum spacing of the bow handle relative to the axis of rotation, in particular viewed along the direction perpendicular to the axis of rotation, is preferably between 20% and 50% of a value of a maximum longitudinal extension of the housing apparatus. The maximum longitudinal extension of the housing apparatus is preferably between 400 mm and 500 mm, preferably between 425 mm and 450 mm and particularly preferably 435 mm. The maximum longitudinal extension of the housing apparatus extends in particular at least substantially parallel to the axis of rotation. A minimum spacing between the handle housing, in particular the bow handle, and the gearbox housing, in particular at least viewed along the direction parallel to the axis of rotation, is preferably between 75 mm and 125 mm, preferably between 95 mm and 105 mm and most particularly preferably 100 mm. Preferably viewed along the direction parallel to the axis of rotation, the minimum spacing between the handle housing and the gearbox housing preferably extends between two facing, and in particular closest, outer surfaces of the handle housing, in particular the handle housing base body and the gearbox housing. A maximum handle diameter of the bow handle viewed along an axis parallel to the main extension plane of the bow handle in an actuated state of the control element is preferably between 50 mm and 60 mm, preferably 55 mm. A maximum handle diameter of the bow handle viewed along a direction parallel to the main extension plane of the bow handle in an unactuated state of the control element is preferably between 60 mm and 70 mm, particularly preferably 65 mm. The maximum handle diameter of the bow handle viewed along the direction parallel to the main extension plane of the bow handle in an actuated and/or in an unactuated state of the control element is preferably measured viewed along a direction perpendicular to the central fiber of the bow handle. The maximum handle diameter of the bow handle viewed along the direction parallel to the main extension plane of the bow handle in an actuated and/or in an unactuated state of the control element preferably extends from a gripping surface of the bow handle facing the handle housing, in particular the handle housing base body, preferably a surface of the control element, to a gripping surface of the bow handle facing away from the handle housing, in particular the handle housing base body. A maximum handle diameter of the bow handle viewed along a direction perpendicular to the main extension plane of the bow handle is preferably between 35 mm and 45 mm, preferably 42 mm. The maximum handle diameter of the bow handle viewed along the direction perpendicular to the main extension plane of the bow handle is measured viewed along a direction perpendicular to the central fiber. The maximum handle diameter of the bow handle viewed along the direction perpendicular to the main extension plane of the bow handle is preferably a spacing of two gripping surfaces of the bow handle which face away from one another. The bow handle preferably comprises at least one handle portion having a perimeter, which in particular extends in a plane perpendicular to the central fiber of the bow handle, between 140 mm and 170 mm, preferably between 150 mm and 160 mm and particularly preferably 155 mm. The bow handle preferably comprises at least one further handle portion having a perimeter, which in particular extends in a plane perpendicular to the central fiber of the bow handle, between 150 mm and 180 mm, preferably between 160 mm and 170 mm and particularly preferably 166 mm. The further handle portion is preferably disposed such that, viewed along the direction parallel to the axis of rotation starting from the motor housing, it follows the handle portion. Alternatively, however, it is also conceivable that the housing apparatus has other dimensions, in particular depending on the maximum longitudinal extension of the housing apparatus. The handle housing can advantageously be held particularly comfortably by a user. A rotation of the handle housing relative to the motor housing can advantageously be achieved with a particularly small amount of force.

It is also proposed that the bow handle has a maximum handle length of at least 250 mm. In an alternative embodiment, it is conceivable that the housing apparatus is configured independently of the fact that, viewed along the direction perpendicular to the axis of rotation, the bow handle projects largely beyond the motor housing. In the alternative configuration, in particular in the configuration that is independent of fact that, viewed along the direction perpendicular to the axis of rotation, the bow handle projects largely beyond the motor housing, the housing apparatus preferably comprises at least the handle housing which comprises at least the bow handle, at least the motor housing which comprises the storage area in which the drive unit of the hand-held power tool can be disposed and which specifies an orientation of the axis of rotation of the drive unit, wherein the handle housing in particular the bow handle, is disposed on the motor housing on the side of the motor housing facing away from the gearbox housing connection region of the motor housing, and at least the battery pack interface for placement of the at least one battery pack, which is disposed on the handle housing on the side of the handle housing facing away from the bow handle, wherein the bow handle has a maximum handle length of at least 250 mm. The maximum handle length is preferably measured along the central fiber of the bow handle. The maximum handle length of the bow handle is preferably at most 350 mm. The maximum handle length of the bow handle is preferably between 280 mm and 320 mm, particularly preferably between 295 mm and 315 mm. The maximum handle length is in particular between 60% and 80% of a value of the maximum longitudinal extension of the housing apparatus. In particular viewed along the central fiber, the bow handle is delimited on both sides by the handle housing base body. In particular viewed along the central fiber of the bow handle, the bow handle preferably extends on both sides to a point at which the handle merges into the handle housing base body. The user can advantageously grip the bow handle particularly flexibly in different positions. Particularly comfortable ergonomics of the bow handle can advantageously be achieved.

It is also proposed that the bow handle comprises at least one, in particular the previously already mentioned, gripping surface which, viewed along the direction parallel to the axis of rotation, is spaced apart from the motor housing and faces the handle housing, in particular the handle housing base body, and, viewed along the direction parallel to the axis of rotation, comprises at least two gripping surface portions which, viewed in a direction perpendicular to the axis of rotation, enclose an angle of at least 70°. In an alternative embodiment, it is conceivable that the housing apparatus is configured independently of the fact that, viewed along the direction perpendicular to the axis of rotation, the bow handle projects largely beyond the motor housing. In the alternative configuration, in particular in the configuration that is independent of fact that, viewed along the direction perpendicular to the axis of rotation, the bow handle projects largely beyond the motor housing, the housing apparatus preferably comprises at least the handle housing which comprises at least the bow handle, at least the motor housing which comprises the storage area in which the drive unit of the hand-held power tool can be disposed and which specifies an orientation of the axis of rotation of the drive unit, wherein the handle housing in particular the bow handle, is disposed on the motor housing on the side of the motor housing facing away from the gearbox housing connection region of the motor housing, and at least the battery pack interface for placement of the at least one battery pack, which is disposed on the handle housing on the side of the handle housing facing away from the bow handle, wherein the bow handle comprises at least one gripping surface which faces the handle housing and, viewed along the direction parallel to the axis of rotation, is spaced apart from the motor housing, and, viewed along the direction parallel to the axis of rotation, comprises at least two gripping surface portions which, viewed in the direction perpendicular to the axis of rotation, enclose an angle of at least 70°. A minimum spacing of the gearbox housing to the gripping surface of the bow handle facing the handle housing, in particular the handle housing base body, at least viewed along the direction parallel to the axis of rotation, is preferably between 160 mm and 200 mm, preferably between 170 mm and 190 mm and particularly preferably 180 mm. The minimum spacing of the gearbox housing to the gripping surface of the bow handle facing the handle housing, in particular the handle housing base body, is preferably a spacing between a point of a surface of the gearbox housing facing the handle housing, in particular the point closest to the handle housing, and a part of the gripping surface closest to the motor housing. A value of the minimum spacing of the gearbox housing to the gripping surface is in particular between 35% and 45% of a value of the maximum longitudinal extension, preferably at least viewed along the direction parallel to the axis of rotation. The control element is preferably disposed on the gripping surface. The control element preferably extends at least partly along the at least two gripping surface portions. The at least two gripping surface portions of the gripping surface facing the handle housing, preferably the handle housing base body, in particular each have a tangent, which together enclose an angle of at least 70°. The tangents of the two gripping surface portions of the gripping surface facing the handle housing, in particular the handle housing base body, preferably extend parallel to the main extension plane of the bow handle, particularly preferably in the main extension plane of the bow handle. The gripping surface, and in particular the at least two gripping surface portions, are preferably curved at least in sections viewed along the direction parallel to the axis of rotation. At least one gripping surface portion of the at least two gripping surface portions preferably extends at least partly on a side of the control element facing the motor housing, at least viewed along the direction parallel to the axis of rotation. The gripping surface portion preferably extends from an end of the bow handle that is in particular delimited by the handle housing base body, preferably from a point of intersection of the gripping surface with the handle housing base body, to a midpoint of the control element, preferably viewed along the direction parallel to the axis of rotation. At least one further gripping surface portion of the at least two gripping surface portions is preferably disposed at least partly on a side of the control element facing away from the motor housing, at least viewed along the direction parallel to the axis of rotation. The further gripping surface portion preferably extends from an end of the bow handle that is in particular delimited by the handle housing base body, preferably from a point of intersection of the gripping surface with the handle housing base body, to a midpoint of the control element, preferably viewed along the direction parallel to the axis of rotation. The control element in particular comprises a central fiber. The central fiber of the control element extends in particular over an entire maximum longitudinal extension of the control element through cross-sectional midpoints of the control element. The midpoint of the control element is disposed on the central fiber of the control element, in particular in the middle along the maximum longitudinal extension of the control element. The at least two gripping surface portions are in particular adjacent to one another, in particular merge directly into one another. Preferably at least viewed along the direction parallel to the axis of rotation, a transition between the at least two gripping surface portions is particularly preferably continuous, in particular without steps. Alternatively, it is also conceivable that the two gripping surface portions adjoin one another such that at least one step is formed between the two gripping surface portions, in particular at least viewed along the direction parallel to the axis of rotation. Viewed along the central fiber of the bow handle, the bow handle preferably has a curved profile at least in sections. Alternatively or additionally, it is also conceivable that, viewed along the central fiber of the bow handle, the bow handle has a stepped and/or a straight profile at least in sections. Particularly ergonomic holding of the bow handle for a user can advantageously be realized. The two differently oriented gripping surface portions advantageously make it possible to provide a bow handle that enables particularly comfortable and/or ergonomic hand positions for a user on the bow handle, both when carrying the housing apparatus and when working with the hand-held power tool comprising the housing apparatus.

It is further proposed that a gripping surface portion, in particular the previously already mentioned gripping surface portion of a gripping surface of the bow handle encloses an angle with a value between 40° and 50° with an axis which extends parallel to the axis of rotation. In an alternative embodiment, it is conceivable that the housing apparatus is configured independently of the fact that, viewed along the direction perpendicular to the axis of rotation, the bow handle projects largely beyond the motor housing. In the alternative configuration, in particular in the configuration that is independent of fact that, viewed along the direction perpendicular to the axis of rotation, the bow handle projects largely beyond the motor housing, the housing apparatus preferably comprises at least the handle housing which comprises at least the bow handle, at least the motor housing which comprises the storage area in which the drive unit of the hand-held power tool can be disposed and which specifies an orientation of the axis of rotation of the drive unit, wherein the handle housing in particular the bow handle, is disposed on the motor housing on the side of the motor housing facing away from the gearbox housing connection region of the motor housing, and at least the battery pack interface for placement of the at least one battery pack, which is disposed on the handle housing on the side of the handle housing facing away from the bow handle, wherein a gripping surface portion, in particular the previously already mentioned gripping surface portion, in particular of the previously already mentioned gripping surface of the bow handle encloses an angle with a value between 40° and 50° with the axis which extends parallel to the axis of rotation. The gripping surface portion in particular has at least one tangent, which preferably extends in the main extension plane of the bow handle and encloses an angle with a value between 40° and 50° with the axis of rotation. The bow handle is preferably configured on the gripping surface portion that encloses an angle between 40° and 50° with an axis which extends parallel to the axis of rotation such that a user can grasp the bow handle at the gripping surface portion in such a way that a grip axis of a user's hand encloses an angle with a value between 40° and 50° with the axis of rotation. In at least one embodiment example, the angle enclosed by the gripping surface portion and the axis which extends parallel to the axis of rotation having a value between 40° and 50° is preferably measured at a point of intersection of the gripping surface portion with the handle housing base body. The angle enclosed by the gripping surface portion and the axis which extends parallel to the axis of rotation is preferably measured on a side of the axis which extends parallel to the axis of rotation that faces away from the handle housing. The gripping surface portion is in particular configured such that, depending on a measuring point, the gripping surface portion, in particular the tangent of the gripping surface portion which preferably extends in the main extension plane of the bow handle, encloses an angle with the axis which extends parallel to the axis of rotation that has a value in an angular range of −40° to 100°. Advantageously, a bow handle can be provided, which comprises a gripping surface portion, the orientation of which enables a particularly comfortable and/or ergonomic hand position for a user when using the hand-held power tool comprising the housing apparatus and configured as angle grinder for cutting work. For different types of work, in particular for cutting work, the bow handle can advantageously be held in such a way that a grip axis of a user's hand encloses an angle between 65° and 75° with a forearm axis of the user in order to enable particularly ergonomic holding of the bow handle.

It is further proposed that a gripping surface portion, in particular the previously already mentioned further gripping surface portion of a gripping surface of the bow handle, in particular the previously already mentioned gripping surface of the bow handle, encloses an angle with a value between 90° and 120° with the axis of rotation. In an alternative embodiment, it is conceivable that the housing apparatus is configured independently of the fact that, viewed along the direction perpendicular to the axis of rotation, the bow handle projects largely beyond the motor housing. In the alternative configuration, in particular in the configuration that is independent of fact that, viewed along the direction perpendicular to the axis of rotation, the bow handle projects largely beyond the motor housing, the housing apparatus preferably comprises at least the handle housing which comprises at least the bow handle, at least the motor housing which comprises the storage area in which the drive unit of the hand-held power tool can be disposed and which specifies an orientation of the axis of rotation of the drive unit, wherein the handle housing in particular the bow handle, is disposed on the motor housing on the side of the motor housing facing away from the gearbox housing connection region of the motor housing, and at least the battery pack interface for placement of the at least one battery pack, which is disposed on the handle housing on the side of the handle housing facing away from the bow handle, wherein a gripping surface portion, in particular the previously already mentioned further gripping surface portion of a gripping surface of the bow handle, in particular the previously already mentioned gripping surface of the bow handle encloses an angle with a value between 90° and 120° with the axis of rotation. The further gripping surface portion in particular has at least one tangent, which preferably extends in the main extension plane of the bow handle and encloses an angle with a value between 90° and 120° with the axis of rotation. The further gripping surface portion in particular has at least one tangent, which encloses an angle with a value between 90° and 120° with the axis of rotation. The bow handle is preferably configured on the further gripping surface portion that encloses an angle with a value between 90° and 120° with the axis of rotation such that a user can grasp the bow handle at the further gripping surface portion in such a way that a grip axis of a user's hand encloses an angle with a value between 90° and 120° with the axis of rotation. In at least one embodiment example, the angle enclosed by the further gripping surface portion and the axis of rotation is preferably measured at a point of intersection of the further gripping surface portion with the axis of rotation; preferably measured on a side of the axis of rotation facing the control element. Advantageously, a bow handle can be provided, which comprises a gripping surface portion, in particular the further gripping surface portion, the orientation of which enables a particularly comfortable and/or ergonomic hand position for a user when carrying the housing apparatus. For different types of work, in particular when carrying the device apparatus, the bow handle can advantageously be held in such a way that a grip axis of a user's hand encloses an angle between 65° and 75° with a forearm axis of the user in order to enable particularly ergonomic holding of the bow handle.

It is also proposed that the bow handle comprises at least one, in particular the previously already mentioned control element, which, viewed along a, in particular the previously already mentioned, maximum handle length of the bow handle, is disposed in a central region of the bow handle, wherein a value of a maximum longitudinal extension of the control element is at least 20% of a value of the maximum handle length of the bow handle. In an alternative embodiment, it is conceivable that the housing apparatus is configured independently of the fact that, viewed along the direction perpendicular to the axis of rotation, the bow handle projects largely beyond the motor housing. In the alternative configuration, in particular in the configuration that is independent of fact that, viewed along the direction perpendicular to the axis of rotation, the bow handle projects largely beyond the motor housing, the housing apparatus preferably comprises at least the handle housing which comprises at least the bow handle, at least the motor housing which comprises the storage area in which the drive unit of the hand-held power tool can be disposed and which specifies an orientation of the axis of rotation of the drive unit, wherein the handle housing in particular the bow handle, is disposed on the motor housing on the side of the motor housing facing away from the gearbox housing connection region of the motor housing, and at least the battery pack interface for placement of the at least one battery pack, which is disposed on the handle housing on the side of the handle housing facing away from the bow handle, wherein the bow handle comprises at least one, in particular the previously already mentioned control element, which, viewed along a, in particular the previously already mentioned, maximum handle length of the bow handle, is disposed in a central region of the bow handle, wherein a value of the maximum longitudinal extension of the control element is at least 20% of a value of the maximum handle length of the bow handle. The maximum longitudinal extension of the control element is preferably measured along the central fiber of the control element. Viewed along the direction parallel to the axis of rotation, the control element, in particular the central fiber of the control element, preferably has an at least partly curved profile. Alternatively or additionally, it is also conceivable that the central fiber of the control element extends at least partly at an angle and/or in a straight line, at least viewed along the direction parallel to the axis of rotation. The central fiber of the control element is preferably at least substantially parallel to the central fiber of the bow handle. A value of the maximum longitudinal extension of the control element is particularly preferably at least 30% of a value of the maximum handle length of the bow handle. A value of the maximum longitudinal extension of the control element is preferably at most 50%, particularly preferably at most 40%, of a value of the maximum handle length of the bow handle. The maximum longitudinal extension of the control element is in particular between 90 mm and 110 mm. However, other dimensions for the control element deemed appropriate by those skilled in the art, in particular relative to the maximum handle length of the bow handle, are alternatively conceivable as well. The central region of the bow handle preferably extends around a midpoint of the bow handle, at least viewed along the central fiber of the bow handle. A value of a maximum extension of the central region of the bow handle along the central fiber of the bow handle starting from the midpoint of the bow handle is preferably at least 20% of a value of the maximum handle length of the bow handle, preferably on a side of the midpoint of the bow handle facing and/or facing away from the motor housing. A value of a maximum extension of the central region of the bow handle along the central fiber of the bow handle starting from the midpoint of the bow handle is particularly preferably at most 40%, particularly preferably at most 30%, of a value of the maximum handle length of the bow handle, preferably on a side of the midpoint of the bow handle facing and/or facing away from the motor housing. The maximum extension of the central region of the bow handle along the central fiber of the bow handle starting from the midpoint of the bow handle is in particular between 50 mm and 120 mm, particularly preferably between 60 mm and 90 mm, in particular on a side of the midpoint of the bow handle facing and/or facing away from the motor housing. The control element is preferably disposed on a side of the bow handle facing the handle housing, in particular the handle housing base body. However, it is also conceivable that the control element is disposed on a side of the bow handle facing away from the handle housing, in particular the handle housing base body. A maximum longitudinal extension of the control element is preferably between 80 mm and 120 mm, particularly preferably between 90 mm and 110 mm. Alternatively, however, it is also conceivable that the control element has a different value, in particular outside a range between 80 mm and 120 mm, for the maximum longitudinal extension. A value of a maximum extension of the central region of the bow handle starting from the central fiber along a direction perpendicular to the central fiber of the bow handle is between 5% and 15% of a value of the maximum handle length of the bow handle. Starting from the central fiber, the maximum extension of the central region of the bow handle along the direction perpendicular to the central fiber of the bow handle is preferably between 25 mm and 35 mm. A bow handle can advantageously be provided, which enables a particularly high number of different hand positions on the bow handle that at the same time enable particularly comfortable actuation of the control element. A particularly high level of operating comfort can advantageously be achieved.

A hand-held power tool, in particular the previously already mentioned hand-held power tool, in particular an angle grinder, with a housing apparatus according to the invention and with a drive unit, in particular the previously already mentioned drive unit, which comprises the axis of rotation, is proposed as well. The hand-held power tool is preferably configured as an angle grinder. Alternatively, however, it is also conceivable that the hand-held power tool is configured as a drill, as a hammer drill and/or chisel hammer, as a reciprocating saw, as a power saw, or as another hand-held power tool deemed appropriate by those skilled in the art. The hand-held power tool preferably comprises at least one insert tool holder for, in particular rotationally fixed, connection to an insert tool and/or for axially securing the insert tool. In particular in at least one operating position of the motor housing relative to the handle housing, the insert tool holder is preferably disposed on the gearbox housing on a side of the handle housing facing away from the bow handle. The insert tool is preferably configured as a grinding wheel or a cutting wheel. A maximum diameter of an insert tool configured as a cutting wheel or grinding wheel is 180 mm or 230 mm, for example. However, other values for the maximum diameter are alternatively conceivable as well. However, it is also conceivable that the insert tool is configured as another insert tool deemed appropriate by those skilled in the art, in particular depending on a design of the hand-held power tool. The hand-held power tool preferably comprises at least one gearbox unit, which is disposed in the gearbox housing of the housing apparatus. The hand-held power tool in particular comprises at least one hand-held power tool electronics that are disposed at least substantially entirely in the handle housing. The hand-held power tool electronics are most particularly preferably disposed entirely in the handle housing. In particular 100% of a total volume of the hand-held power tool electronics is disposed in the handle housing. The hand-held power tool electronics comprise at least one regulating or control unit for regulating or controlling the drive unit, for instance. The regulating or control unit preferably comprises at least one processor and a memory unit as well as an operating program stored on the memory unit. The hand-held power tool electronics are preferably electrically connected to the battery pack interface and/or the drive unit. The components of the hand-held power tool electronics are preferably disposed on a common circuit board and/or advantageously disposed in a common housing. Advantageously, a hand-held power tool can be provided, which provides a user a particularly high level of comfort when operating and/or when carrying the hand-held power tool. A hand-held power tool with a particularly ergonomic bow handle can be made available.

It is further proposed that the hand-held power tool has a maximum hand-held power tool longitudinal extension, wherein a value of a spacing, in particular the previously already mentioned maximum spacing of the bow handle from the axis of rotation, is at least 20% of a value of the maximum hand-held power tool longitudinal extension, at least viewed along a direction perpendicular to the axis of rotation. The maximum hand-held power tool longitudinal extension preferably corresponds to the maximum longitudinal extension of the housing apparatus. A hand-held power tool can advantageously be held particularly comfortably, in particular when carrying and/or operating the hand-held power tool.

It is further proposed that the hand-held power tool comprises hand-held power tool electronics, in particular the previously already mentioned hand-held power tool electronics, and at least one electrical connecting element for electrically connecting the drive unit to the hand-held power tool electronics and/or the battery pack interface, wherein, at a pivot joint of the housing apparatus, by means of which the handle housing is movably mounted on the motor housing, the electrical connecting element has an excess length in order to enable a rotation of the handle housing relative to the motor housing. The pivot joint allows the motor housing to preferably be rotatable relative to the handle housing, in particular about the rotary axis of the pivot joint, preferably by at least 90°. The housing apparatus of the hand-held power tool configured as angle grinder preferably has at least two different operating positions. One of the two operating positions, in which the insert tool holder is disposed on a side of the handle housing facing away from the bow handle, is preferably a grinding and/or roughing position. Another of the two operating positions, in which the insert tool holder is preferably rotated 90° about the axis of rotation to the grinding and/or roughing position, is in particular a cutting position. At least in a grinding and/or roughing position, the output axis preferably extends in the main extension plane of the bow handle. In particular in a cutting position, the output axis extends at least substantially perpendicular to the main extension plane of the bow handle. The electrical connecting element is preferably configured as a cable or the like. The electrical connecting element is preferably configured such that the excess length enables a rotation of the motor housing relative to the handle housing by at least 90°. Alternatively, it is also conceivable that the hand-held power tool comprises a sliding contact unit, which comprises at least one slip ring, for example, in particular in the region of the pivot joint, or the like, for electrically connecting the drive unit to the hand-held power tool electronics and/or the battery pack interface. A bow handle can advantageously be adapted particularly flexibly and ergonomically to an activity to be carried out while at the same time protecting the connecting electronics. A robust hand-held power tool with a particularly high level of operating comfort can advantageously be provided.

The housing apparatus according to the invention and/or the hand-held power tool according to the invention are not intended to be limited to the above-described application and embodiment. In order to carry out a function described here, the housing apparatus and/or the hand-held power tool according to the invention can in particular comprise a number of individual elements, components and units that differs from a number specified here. Moreover, for the ranges of values indicated in this disclosure, values lying within the mentioned limits are also intended to be considered disclosed and usable as desired.

### DRAWINGS

Further advantages will become apparent from the following description of the drawing. The drawing shows three embodiment examples of the invention. The drawing, the description and the claims contain numerous features in combination. The person skilled in the art will expediently also consider the features individually and combine them into meaningful further combinations.

The figures show:

FIG. 1 A hand-held power tool according to the invention comprising a housing apparatus according to the invention in a side view,

FIG. 2 a sectional view through the hand-held power tool according to the invention of FIG. 1,

FIG. 3 a side view of a hand-held power tool according to the invention comprising a housing apparatus according to the invention in a first alternative embodiment,

FIG. 4 a sectional view through the hand-held power tool according to the invention in the first alternative embodiment of FIG. 3,

FIG. 5 a side view of a hand-held power tool according to the invention comprising a housing apparatus according to the invention in a second alternative embodiment, and

FIG. 6 a sectional view through a portion of the hand-held power tool according to the invention in the second alternative embodiment of FIG. 5.

### DESCRIPTION OF THE EMBODIMENT EXAMPLES

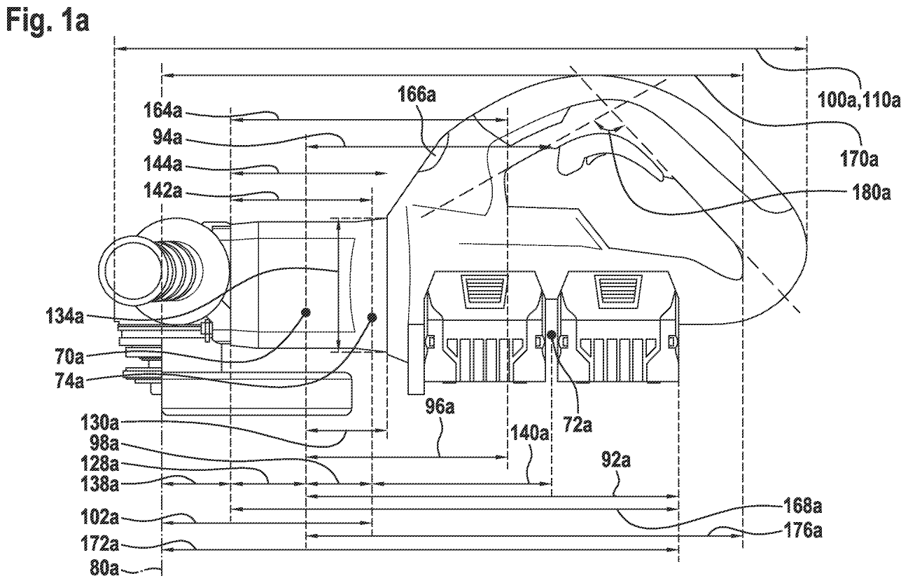

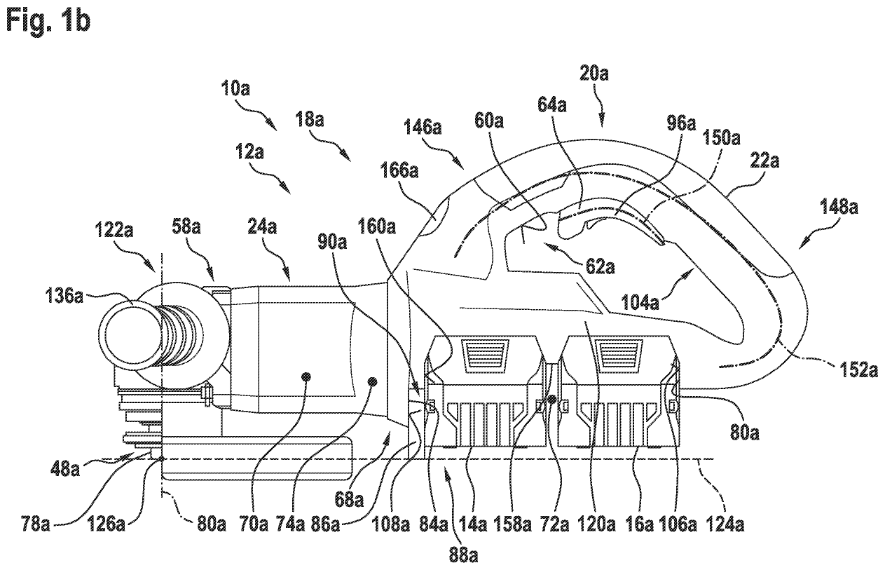

FIG. 1 shows a hand-held power tool system 10a comprising a hand-held power tool 12a. The hand-held power tool system 10a comprises two battery packs 14a, 16a. Alternatively, it is also conceivable that the hand-held power tool system 10a comprises only one battery pack or more than two battery packs. The hand-held power tool 12a is configured as an angle grinder. Alternatively, it is also conceivable that the hand-held power tool 12a is configured as another hand-held power tool 12a deemed appropriate by those skilled in the art, for example as a drill, as a hammer drill and/or chisel hammer, as a reciprocating saw, as a power saw or the like. The hand-held power tool 12a comprises a gearbox unit 76a. The hand-held power tool 12a, in particular the gearbox unit 76a of the hand-held power tool 12a, comprises at least one output spindle 78a. The hand-held power tool 12a comprises at least one drive unit 28a. The drive unit 28a comprises at least one electric motor or the like. The drive unit 28a is provided for driving the output spindle 78a.

The hand-held power tool 12a comprises at least one housing apparatus 18a. The housing apparatus 18a is configured as a hand-held power tool housing. The housing apparatus 18a comprises at least one handle housing 20a. The housing apparatus 18a comprises at least one motor housing 24a. The motor housing 24a comprises at least one storage area 26a, in which the drive unit 28a of the hand-held power tool 12a can be disposed. The storage area 26a defines an orientation of an axis of rotation 30a of the drive unit 28a. The handle housing 20a comprises at least one bow handle 22a. The handle housing 20a comprises at least one handle housing base body 120a on which the bow handle 22a is disposed. The handle housing base body 120a is disposed on the motor housing 24a. Viewed along a direction parallel to the axis of rotation 30a, the handle housing 20a, in particular the bow handle 22a and/or the handle housing base body 120a, are/is disposed on the motor housing 24a at least substantially entirely on a side of the motor housing 24a facing away from a gearbox housing connection region 58a. The handle housing 20a, in particular the handle housing base body 120a, is movably mounted on the motor housing 24a, in particular mounted on the motor housing 24a such that it can be rotated relative to the motor housing 24a by means of a pivot joint 68a of the housing apparatus 18a. The housing apparatus 18a in particular comprises an actuating element 166a, which is configured as a button or the like, for example. The actuating element 166a is disposed on the bow handle 22a. When the actuating element 166a is actuated by a user, a latched connection between the handle housing 20a and the motor housing 24a can be released to enable rotation of the handle housing 20a relative to the motor housing 24a by means of the pivot joint 68a. In an unpressed state of the actuating element 166a, the handle housing 20a is latched to the motor housing 24a in a rotationally fixed manner. The handle housing 20a is mounted on the motor housing 24a such that it can be rotated about a rotary axis 154a of the pivot joint 68a by means of the pivot joint 68a. The rotary axis 154a in particular extends at least substantially parallel to the axis of rotation 30a. The rotary axis 154a particularly preferably corresponds to the axis of rotation 30a. Alternatively, however, it is also conceivable that the rotary axis 154a extends at an angle to the axis of rotation 30a. The housing apparatus 18a comprises at least one gearbox housing 122a. The gearbox housing 122a is disposed on the motor housing 24a, in particular on a side of the motor housing 24a facing away from the handle housing 20a. The gearbox housing 122a is fixedly connected to the motor housing 24a. The gearbox unit 76a is disposed on, preferably at least partly in, the gearbox housing 122a. The output spindle 78a is disposed on the gearbox housing 122a, in particular mounted in the gearbox housing 122a. An orientation of an output axis 80a of the output spindle 78a is defined by the gearbox housing 122a. The output spindle 78a is preferably mounted in the gearbox housing 122a such that it can rotate about the output axis 80a. The output axis 80a extends at least substantially perpendicular to the axis of rotation 30a and/or a main extension axis of the hand-held power tool 12a.

The hand-held power tool 12a comprises at least one insert tool holder 48a for placement of an insert tool (not shown here). The hand-held power tool 12a comprises the insert tool holder 48a for, in particular rotationally fixed, connection to an insert tool and/or for axially securing the insert tool. In particular in at least one operating position of the motor housing 24a relative to the handle housing 20a, the insert tool holder 48a is preferably disposed on the gearbox housing 122a on a side of the handle housing 20a facing away from the bow handle 22a. In at least one operating state, the insert tool holder 48a is disposed on the gearbox housing 122a on a side of the handle housing 20a, in particular the handle housing base body 120a, facing away from the bow handle 22a. The insert tool is configured as a grinding wheel or a cutting wheel. Alternatively, however, it is also conceivable that the insert tool is configured as another insert tool deemed appropriate by those skilled in the art.

The hand-held power tool 12a comprises at least one hand-held power tool electronics 46a. The hand-held power tool electronics 46a are disposed at least substantially entirely in the handle housing 20a, in particular the handle housing base body 120a. The hand-held power tool electronics 46a comprise at least one control or regulating unit (not shown here) for regulating or controlling the drive unit 28a, for instance. The regulating or control unit comprises at least one processor and a memory unit as well as an operating program stored on the memory unit. The components of the hand-held power tool electronics 46a are disposed on a common circuit board. It is also conceivable that the components of the hand-held power tool electronics 46a are disposed in a common housing.

The housing apparatus 18a comprises at least one battery pack interface 40a for placement of the at least two battery packs 14a, 16a. The battery pack interface 40a is provided for electrically and mechanically contacting the at least two battery packs 14a, 16a. The battery pack interface 40a comprises electrical and/or mechanical contact elements for contacting the at least two battery packs 14a, 16a. The battery pack interface 40a is configured such that an insertion direction of the at least two battery packs 14a, 16a for placement on the battery pack interface 40a extends at least substantially perpendicular to the axis of rotation 30a. The insertion direction is at least substantially perpendicular to a main extension plane of the bow handle 22a. Alternatively, it is also conceivable that the insertion direction extends at least substantially parallel to the main extension plane of the bow handle 22a, in particular at least substantially parallel or at least substantially perpendicular to the axis of rotation 30a. It is furthermore alternatively also conceivable that the insertion direction is angled, in particular other than perpendicular, to the main extension plane of the bow handle 22a. The axis of rotation 30a extends in the main extension plane of the bow handle 22a. The battery pack interface 40a is disposed on the handle housing 20a, in particular the handle housing base body 120a. The hand-held power tool electronics 46a are electrically connected to the battery pack interface 40a and/or the drive unit 28a. The at least two battery packs 14a, 16a are configured as 18 V battery packs. Alternatively, it is conceivable that the at least two battery packs 14a, 16a have other battery voltages deemed appropriate by those skilled in the art. The at least two battery packs 14a, 16a each have a battery capacity of 12 Ah. Alternatively, it is conceivable that at least one of the two battery packs 14a, 16a has a battery capacity other than 12 Ah, for example a battery capacity between 1 Ah and 15 Ah, preferably between 2 Ah and 12 Ah. It is in particular conceivable that the at least two battery packs 14a, 16a have a matching battery capacity or different battery capacities. The battery pack interface 40a is preferably provided to accommodate one 36 V battery pack (not shown here) instead of the at least two battery packs 14a, 16a configured as 18 V battery packs. Alternatively or additionally, it is furthermore also conceivable that the battery pack interface 40a is provided for placement of more than two battery packs 14a, 16a. It is conceivable that the two battery packs 14a, 16a each comprise a single battery cell layer, which is in particular formed by a battery cell embodied in flat construction or by a plurality of cylindrical battery cells. It is also conceivable that the two battery packs 14a, 16a each comprise at least two battery cell layers, which are respectively formed by a battery cell embodied in flat construction or by a plurality of cylindrical battery cells. The battery pack interface 40a is configured such that, in a state in which the battery packs are disposed on the battery pack interface 40a, the two battery packs 14a, 16a are disposed one behind the other viewed along the direction parallel to the axis of rotation 30a.

The battery pack interface 40a is disposed in an immediate vicinity of the axis of rotation 30a of the drive unit 28a. The immediate vicinity of the axis of rotation 30a has a maximum extension starting from the axis of rotation 30a and extending perpendicular to the axis of rotation 30a, the value of which is at most 50% of a value of a maximum extension 116a of the motor housing 24a starting from the axis of rotation 30a viewed along a direction perpendicular to the axis of rotation 30a. The battery pack interface 40a is disposed at least substantially entirely within the immediate vicinity of the axis of rotation 30a. It is alternatively also conceivable that the battery pack interface 40a is disposed only partly in the immediate vicinity of the axis of rotation 30a.

Viewed along the direction perpendicular to the axis of rotation 30a, a maximum extension 134a of the motor housing 24a is between 50 mm and 100 mm, preferably between 70 mm and 80 mm and particularly preferably 75 mm. A perimeter of the motor housing 24a, which in particular extends in a plane perpendicular to the axis of rotation 30a, is between 280 mm and 310 mm, preferably between 285 mm and 295 mm and particularly preferably 292 mm. The housing apparatus 18a comprises at least one mounting interface for attaching an auxiliary handle 136a of the hand-held power tool 12a. The mounting interface is disposed on the gearbox housing 122a. It is alternatively also conceivable that the mounting interface is disposed on the motor housing 24a or another component of the housing apparatus 18a. The mounting interface is configured as a thread, for example, in particular as an external thread or as an internal thread. It is furthermore also conceivable that the auxiliary handle 136a can be attached to the housing apparatus 18a, in particular the gearbox housing 122a, by means of straps, a clamp or the like. The mounting interface defines an orientation of a main extension axis of the auxiliary handle 136a. In a state of the auxiliary handle 136a in which it is disposed on the housing apparatus 18a, in particular on the gearbox housing 122a, the main extension axis of the auxiliary handle 136a extends at least substantially perpendicular to the axis of rotation 30a and/or the output axis 80a. A spacing between the mounting interface or a midpoint of a free end of the auxiliary handle 136a disposed on the mounting interface to a midpoint of the bow handle 22a, in particular viewed along the direction parallel to the axis of rotation 30a, is preferably between 310 mm and 360 mm, preferably between 330 mm and 340 mm and particularly preferably 335 mm. The midpoint of the bow handle 22a is disposed on a central fiber 152a of the bow handle 22a in the middle of a maximum longitudinal extension of the bow handle along the central fiber 152a. A central fiber of an object, in particular the central fiber 152a of the bow handle 22a, preferably extends over an entire maximum longitudinal extension of the object, in particular the entire maximum longitudinal extension of the bow handle 22a, through cross-sectional midpoints of the object, in particular the bow handle 22a. The cross-sectional midpoints of the object, in particular the bow handle 22a, are respectively formed by a midpoint, in particular a geometric center of gravity of a cross-sectional area of the object, in particular the bow handle 22a. The respective cross-sectional area of the object, in particular the bow handle 22a, extends in a plane that is perpendicular to a main extension plane of the object, in particular the main extension plane of the bow handle 22a. The respective cross-sectional area of the object, in particular the bow handle 22a, particularly preferably extends at least substantially perpendicular to an outer wall of the object, in particular the bow handle 22a, which delimits the respective cross-sectional area. A course of the central fiber of the object, in particular the central fiber 152a of the bow handle 22a, is defined by a shape of the object, in particular the bow handle 22a, viewed along the maximum longitudinal extension of the object, in particular the bow handle 22a. Viewed along the direction parallel to the axis of rotation 30a, a minimum spacing 138a between the output axis 80a and the motor housing 24a, in particular a gearbox connection point of the motor housing 24a, is preferably between 35 mm and 65 mm, preferably between 40 mm and 60 mm and particularly preferably 50 mm. Alternatively, however, it is also conceivable that the housing apparatus 18a has other dimensions, in particular depending on a maximum longitudinal extension 110a of the housing apparatus 18a.

In at least one operating state, in particular in a grinding and/or roughing position of the hand-held power tool 12a, the two battery packs 14a, 16a are disposed at least substantially entirely between a plane 124a, which extends perpendicular to the output spindle 78a and intersects a point 126a of the output spindle 78a furthest away from the axis of rotation 30a, and the bow handle 22a, at least viewed along the direction perpendicular to the axis of rotation 30a. The axis of rotation 30a extends at least substantially parallel to the main extension axis of the hand-held power tool 12a.

The hand-held power tool 12a comprises at least one hand-held power tool center of gravity 70a, wherein the battery pack interface 40a is disposed in an immediate vicinity of the hand-held power tool center of gravity 70a. The immediate vicinity of the hand-held power tool center of gravity 70a has a maximum extension starting from the hand-held power tool center of gravity 70a, the value of which is at most 60% of a value of a maximum hand-held power tool longitudinal extension 100a of the hand-held power tool 12a viewed along the direction parallel to the axis of rotation 30a. The maximum hand-held power tool longitudinal extension 100a corresponds to the maximum longitudinal extension 110a of the housing apparatus 18a. The maximum hand-held power tool longitudinal extension 100a of the hand-held power tool 12a and/or the maximum longitudinal extension 110a of the housing apparatus 18a are/is between 400 mm and 500 mm, preferably between 425 mm and 450 mm and particularly preferably 435 mm. The maximum hand-held power tool longitudinal extension 100a and/or the maximum longitudinal extension 110a extend at least substantially parallel to the axis of rotation 30a. The maximum hand-held power tool longitudinal extension 100a is measured in a state of the hand-held power tool 12a in which the insert tool is decoupled from an insert tool holder 48a of the hand-held power tool 12a, in particular is not disposed on the insert tool holder 48a. The maximum extension of the immediate vicinity of the hand-held power tool center of gravity 70a is at most 250 mm, at least viewed along the direction parallel to the axis of rotation 30a. The hand-held power tool center of gravity 70a is disposed in the region of the motor housing 24a, in particular within the motor housing 24a, at least viewed along the direction parallel to the axis of rotation 30a. The hand-held power tool center of gravity 70a is disposed on a side of the axis of rotation 30a facing away from a large part of the bow handle 22a, at least viewed along the direction perpendicular to the axis of rotation 30a. The hand-held power tool center of gravity 70a is a center of gravity of the hand-held power tool 12a in a state in which the battery pack interface 40a is free of attachable battery packs, in particular free of the two battery packs 14a, 16a. The hand-held power tool center of gravity 70a is a center of gravity of the hand-held power tool 12a with the insert tool disposed on the insert tool holder 48a of the hand-held power tool 12a. However, it is also conceivable that the hand-held power tool center of gravity 70a is a center of gravity of the hand-held power tool 12a without an insert tool disposed on the insert tool holder 48a of the hand-held power tool 12a.

A minimum spacing 128a of the hand-held power tool center of gravity 70a to the gearbox housing 122a is between 5% and 15%, preferably at most 10%, of the maximum hand-held power tool longitudinal extension 100a, at least viewed along the direction parallel to the axis of rotation 30a. Viewed along the direction parallel to the axis of rotation 30a, the minimum spacing 128a of the hand-held power tool center of gravity 70a to the gearbox housing 122a extends from the hand-held power tool center of gravity 70a to a point of a surface of the gearbox housing 122a closest to the hand-held power tool center of gravity 70a. The minimum spacing 128a of the hand-held power tool center of gravity 70a to the gearbox housing 122a is between 20 mm and 80 mm, preferably between 30 mm and 40 mm. A minimum spacing 130a of the hand-held power tool center of gravity 70a to the handle housing 20a, in particular the handle housing base body 120a, is preferably between 130 mm and 150 mm and particularly preferably between 135 mm and 145 mm. Viewed along the direction parallel to the axis of rotation 30a, the minimum spacing 130a of the hand-held power tool center of gravity 70a to the handle housing 20a extends from the hand-held power tool center of gravity 70a to a point of a surface of the handle housing 20a closest to the hand-held power tool center of gravity 70a. A value of a maximum extension of the immediate vicinity of the hand-held power tool center of gravity 70 starting from the hand-held power tool center of gravity 70a and viewed along the direction perpendicular to the axis of rotation 30a is at most 50% of a value of the maximum extension 116a of the motor housing 24a starting from the axis of rotation 30a viewed along the direction perpendicular to the axis of rotation 30a.

A value of a maximum spacing 92a of the battery pack interface 40a to the hand-held power tool center of gravity 70a is at most 300 mm, preferably between 250 mm and 280 mm, in particular at least viewed along the direction parallel to the axis of rotation 30a. Viewed along the direction parallel to the axis of rotation 30a, the maximum spacing 92a of the battery pack interface 40a to the hand-held power tool center of gravity 70a extends from the hand-held power tool center of gravity 70a to a point of a surface of the battery pack interface 40a furthest away from the hand-held power tool center of gravity 30a. A value of the maximum spacing 92a of the battery pack interface 40a to the hand-held power tool center of gravity 70a is at most 60% of a value of the maximum hand-held power tool longitudinal extension 100a. The battery pack interface 40a is configured such that, in a state in which the battery packs are disposed on the battery pack interface 40a, a maximum spacing of the hand-held power tool center of gravity 70a to the at least two battery packs 14a, 16a is less than 300 mm. Viewed along the direction parallel to the axis of rotation 30a, the battery pack interface 40a is disposed spaced apart from the hand-held power tool center of gravity 70a. Viewed along the parallel to the axis of rotation 30a, a value of a minimum spacing 132a of the battery pack interface 40a to the hand-held power tool center of gravity 70a is at least 15%, preferably at least 20%, of a value of the maximum hand-held power tool longitudinal extension 100a. The minimum spacing 132a of the battery pack interface 40a to the hand-held power tool center of gravity 70a extends from a point of a surface of the battery pack interface 40a closest to the hand-held power tool center of gravity 70a viewed along the direction parallel to the axis of rotation 30a to the hand-held power tool center of gravity 70a. Viewed along the direction parallel to the axis of rotation 30a, the minimum spacing 132a of the battery pack interface 40a to the hand-held power tool center of gravity 70a is at least 100 mm. However, other dimensions deemed appropriate by those skilled in the art are alternatively conceivable as well. A maximum spacing 168a of the two battery packs 14a, 16a disposed on the battery pack interface to the gearbox housing 122a is between 250 mm and 325 mm, preferably between 275 mm and 300 mm and particularly preferably 287 mm, at least viewed along the direction parallel to the axis of rotation 30a. A value of the maximum spacing 168a of the two battery packs 14a, 16a disposed on the battery pack interface 40a is between 60% and 75% of a value of the maximum hand-held power tool longitudinal extension 100a, at least viewed along the direction parallel to the axis of rotation 30a. The maximum spacing 168a of the two battery packs 14a, 16a disposed on the battery pack interface to the gearbox housing 122a extends from a surface of the gearbox housing 122a facing the two battery packs 14a, 16a to a point of a surface of the two battery packs 14a, 16a which is furthest away from the surface of the gearbox housing 122a and in particular faces away from the gearbox housing 122a. A maximum spacing 172a of the two battery packs 14a, 16a disposed on the battery pack interface 40a to the output axis 80a is between 300 mm and 350 mm, preferably 332 mm, at least viewed along the direction parallel to the axis of rotation 30a. A value of the maximum spacing 172a of the two battery packs 14a, 16a disposed on the battery pack interface 40a to the output axis 80a is between 70% and 80% of a value of the maximum hand-held power tool longitudinal extension 100a, at least viewed along the direction parallel to the axis of rotation 30a. The maximum spacing 172a of the two battery packs 14a, 16a disposed on the battery pack interface 40a to the output axis 80a extends from the output axis 80a along the direction parallel to the axis of rotation 30a to a point of a surface of the two battery packs 14a, 16a furthest away from the output axis 80a.

The battery pack interface 40a has a battery pack center of gravity 72a which is defined by the two battery packs 14a, 16a disposed on the battery pack interface 40a. In the present embodiment example, the battery pack center of gravity 72a is defined by the two battery packs 14a, 16a disposed on the battery pack interface 40a. A value of a maximum spacing 94a of the battery pack center of gravity 72a to the hand-held power tool center of gravity 70a is less than 200 mm, preferably less than 170 mm, in particular at least viewed along the direction parallel to the axis of rotation 30a. The maximum spacing 94a of the battery pack center of gravity 72a to the hand-held power tool center of gravity 70a is at most 50%, particularly preferably at most 40%, of a value of the maximum hand-held power tool longitudinal extension 100a. Viewed along the direction parallel to the axis of rotation 30a, the battery pack center of gravity 72a is covered by the motor housing 24a. An axis perpendicular to the axis of rotation 30a through the battery pack center of gravity 72a intersects the bow handle 22a. A value of a minimum spacing (not shown here) of the battery pack center of gravity 72a to the gearbox housing 122a is at most 250 mm, preferably between 170 mm and 230 mm, particularly preferably between 200 mm and 210 mm, at least viewed along the direction parallel to the axis of rotation 30a.

Viewed along the direction parallel to the axis of rotation 30a, the bow handle 22a is disposed spaced apart from the hand-held power tool center of gravity 70a. Viewed along the direction perpendicular to the axis of rotation 30a, the bow handle 22a projects largely beyond the motor housing 24a. At least viewed along the direction perpendicular to the axis of rotation 30a, at least 50% of a total volume of the bow handle 22a, preferably at least 75% of the total volume of the bow handle 22a, extends beyond the motor housing 24a. The bow handle 22a comprises at least one gripping surface 60a, which in particular faces the handle housing base body 120a. The gripping surface 60a is provided for holding the bow handle 22a, when a user, in particular a hand of the user, is carrying the hand-held power tool 12a and/or is working with the hand-held power tool 12a. A spacing of the gripping surface 60a of the bow handle 22a facing the handle housing 60a, in particular the handle housing base body 120a, relative to the axis of rotation 30a along an axis perpendicular to the axis of rotation 30a is at least partly greater than a maximum extension of the motor housing 24a starting from the axis of rotation 30a along the direction perpendicular to the axis of rotation 30a. Viewed along the direction perpendicular to the axis of rotation 30a, the spacing of the gripping surface 60a of the bow handle 22a relative to the axis of rotation 30a extends, viewed along the direction perpendicular to the axis of rotation 30a, from the axis of rotation 30a to a surface of the gripping surface 60a of the bow handle 22a facing the axis of rotation 30a. Viewed along the direction perpendicular to the axis of rotation 30a, the maximum extension of the motor housing 24a starting from the axis of rotation 30a extends from the axis of rotation 30a to a point of a surface of the motor housing 24a furthest away from the axis of rotation 30a viewed along the direction perpendicular to the axis of rotation 30a. The gripping surface 60a is disposed facing the handle housing 20a, in particular the handle housing base body 120a. A minimum spacing 164a of the gearbox housing 122a to the gripping surface 60a of the bow handle 22a is between 160 mm and 200 mm, preferably between 170 mm and 190 mm and particularly preferably 180 mm, at least viewed along the direction parallel to the axis of rotation 30a. The minimum spacing 164a of the gearbox housing 122a to the gripping surface 60a of the bow handle 22a facing the handle housing 20a, in particular the handle housing base body 120a, is a spacing between a point of a surface of the gearbox housing 122a facing the handle housing 20a and closest to the handle housing 20a and a part of the gripping surface 60a closest to the motor housing 24a. A value of the minimum spacing 164a of the gearbox housing 122a to the gripping surface 60a is between 35% and 45% of a value of the maximum longitudinal extension 110a, at least viewed along the direction parallel to the axis of rotation 30a.

The gripping surface 60a has a minimum spacing 96a from the hand-held power tool center of gravity 70a with a value of at least 120 mm, in particular at least viewed along the direction parallel to the axis of rotation 30a. Viewed along the direction parallel to the axis of rotation 30a, the minimum spacing 96a of the gripping surface 60a of the bow handle 22a facing the handle housing 20a, in particular the handle housing base body 120a to the hand-held power tool center of gravity 70a extends from the hand-held power tool center of gravity 70a to a part of the gripping surface 60a of the bow handle 22a facing the handle housing 20a, in particular the handle housing base body 120a closest to the hand-held power tool center of gravity 70a. Viewed along the direction parallel to the axis of rotation 30a, a value of the minimum spacing 96a of the gripping surface 60a to the hand-held power tool center of gravity 70a is at least 30% of a value of the maximum hand-held power tool longitudinal extension 100a. Viewed along the direction parallel to the axis of rotation 30a, a value of a maximum spacing 176a of the gripping surface 60a to the hand-held power tool center of gravity 70a is at most 80%, preferably at most 70%, of a value of the maximum hand-held power tool longitudinal extension 100a. Viewed along the direction parallel to the axis of rotation 30a, the maximum spacing 176a of the gripping surface 60a facing the handle housing 20a, in particular the handle housing base body 120a, to the hand-held power tool center of gravity 70a viewed along the direction parallel to the axis of rotation 30a extends from the hand-held power tool center of gravity 70a to a part of the gripping surface 60a of the bow handle 22a facing the handle housing 20a, in particular the handle housing base body 120a furthest away from the hand-held power tool center of gravity 70a. Viewed along the direction perpendicular to the axis of rotation 30a starting from the battery pack interface 40a, the bow handle 22a is disposed at least largely behind the axis of rotation 30a. The bow handle 22a comprises at least one control element 64a, which is provided for opening or closing a circuit for influencing a current supply to the drive unit 28a of the hand-held power tool 12a, for example. The control element 64a is configured as a switch, lever, button or the like. Viewed along the direction perpendicular to the axis of rotation 30a, the control element 64a is disposed spaced apart from the motor housing 24a in particular on a side of the handle housing 20a, preferably the handle housing base body 120a, facing away from the battery pack interface 40a. A maximum spacing 170a of the gripping surface 60a facing the handle housing 20a, in particular the handle housing base body 120a, to the output axis 80a is between 370 mm and 410 mm, for instance, particularly preferably 390 mm, at least viewed along the direction parallel to the axis of rotation 30a. A value of the maximum spacing 170a of the gripping surface 60a to the output axis 80a viewed along the direction parallel to the axis of rotation 30a is between 80% and 90% of a value of the maximum hand-held power tool longitudinal extension 100a. The maximum spacing 170a of the gripping surface 60a facing the handle housing 20a, in particular the handle housing base body 120a, to the output axis 80a extends from the output axis 80a parallel to the axis of rotation 30a to a location of the gripping surface 60a facing the handle housing 20a, in particular the handle housing base body 120a furthest away from the output axis 80a.

The hand-held power tool system 10a has an overall system center of gravity 74a, which is formed by the hand-held power tool center of gravity 70a and the battery pack center of gravity 72a of the at least two battery packs 14a, 16a disposed on the battery pack interface 40a. The overall system center of gravity 74a shifts as a result of placing different battery packs on the battery pack interface 40a by at most a length 98a, which is at most 20% of a value of the maximum hand-held power tool longitudinal extension 100a, in particular at least viewed along the direction parallel to the axis of rotation 30a. The overall system center of gravity 74a is located on the motor housing 24a, preferably within the motor housing 24a, at least viewed along the direction parallel to the axis of rotation 30a. However, it is alternatively also conceivable that the overall system center of gravity 74a is disposed on the gearbox housing 122a or another component of the housing apparatus 18a. Viewed along the direction parallel to the axis of rotation 30a, a value of a spacing 140a between the overall system center of gravity 74a and the battery pack center of gravity 72a is between 15% and 35% of a value of the maximum hand-held power tool longitudinal extension 100a. The spacing 140a between the overall system center of gravity 74a and the battery pack center of gravity 72a is between 75 mm and 150 mm, particularly preferably between 100 mm and 125 mm, at least viewed along the direction parallel to the axis of rotation 30a. A value of a minimum spacing 142a of the overall system center of gravity 74a to the gearbox housing 122a viewed along the direction parallel to the axis of rotation 30a is at most 30% of a value of the maximum hand-held power tool longitudinal extension 100a. Viewed along the direction parallel to the axis of rotation 30a, the minimum spacing 142a of the overall system center of gravity 74a to the gearbox housing 122a viewed along the direction parallel to the axis of rotation 30a extends from the overall system center of gravity 74a to a point of a surface of the gearbox housing 122a closest to the overall system center of gravity 74a. Viewed along the direction parallel to the axis of rotation 30a, the minimum spacing 142a of the overall system center of gravity 74a to the gearbox housing 122a is between 100 mm and 120 mm, preferably 110 mm. The overall system center of gravity 74a shifts as a result of placing different battery packs on the battery pack interface 40a by at most 75 mm, in particular at least viewed along the direction parallel to the axis of rotation 30a. As a result of placing the at least two battery packs 14a, 16a, the overall system center of gravity 74a shifts in a direction facing toward the handle housing 20a. A value of a maximum spacing 102a of the overall system center of gravity 74a to the output axis 80a of the output spindle 78a is less than 180 mm, preferably less than 160 mm. A value of the maximum spacing 102a of the overall system center of gravity 74a to the output axis 80a of the output spindle 78a is at most 40% of a value of the maximum hand-held power tool longitudinal extension 100a.

The at least two battery packs 14a, 16a each have a battery pack weight that is between 5% and 60% of a hand-held power tool weight of the hand-held power tool 12a. The hand-held power tool weight is between 3 kg and 5 kg, preferably between 3.5 kg and 4.5 kg and particularly preferably between 3.8 kg and 4 kg. A value of the battery pack weight of one of the two battery packs 14a, 16a is between 0.3 kg and 2.3 kg, in particular depending on an operating voltage and/or battery capacity of the at least one battery pack 14a, 16a. However, it is alternatively also conceivable that the hand-held power tool 12a has a different hand-held power tool weight and/or that the battery packs 14a, 16a each have a different battery pack weight.

A value of a maximum spacing 112a of the bow handle 22a to the axis of rotation 30a is at least 20% of a value of the maximum hand-held power tool longitudinal extension 100a, at least viewed along the direction perpendicular to the axis of rotation 30a. A value of the maximum spacing 112a of the bow handle 22a relative to the axis of rotation 30a viewed along the direction perpendicular to the axis of rotation 30a is between 20% and 50% of a value of the maximum longitudinal extension 110a of the housing apparatus 18a. The maximum spacing 112a of the bow handle 22a relative to the axis of rotation 30a is at least 80 mm, preferably at least 100 mm and particularly preferably at least 110 mm, at least viewed along the direction perpendicular to the axis of rotation 30a. The maximum spacing 112a of the bow handle 22a relative to the axis of rotation 30a viewed along the direction perpendicular to the axis of rotation 30a preferably extends from a gripping surface of the bow handle 22a facing away from the handle housing 20a, in particular the handle housing base body 120a, which is preferably furthest away from the axis of rotation 30a viewed along the perpendicular to the axis of rotation 30a to the axis of rotation 30a. The maximum spacing 112a of the bow handle 22a relative to the axis of rotation 30a viewed along the direction perpendicular to the axis of rotation 30a is at most 200 mm, preferably at most 150 mm and particularly preferably at most 130 mm.

A minimum spacing 144a between the handle housing 20a, in particular the bow handle 22a, and the gearbox housing 122a is between 75 mm and 125 mm, preferably between 95 mm and 105 mm and most particularly preferably 100 mm, in particular at least viewed along the direction parallel to the axis of rotation 30a. The minimum spacing 144a between the handle housing 20a and the gearbox housing 122a extends between two facing, and in particular closest, outer surfaces of the handle housing 20a, in particular the handle housing base body 120a, and the gearbox housing 122a, at least viewed along the direction parallel to the axis of rotation 30a. A maximum handle diameter of the bow handle 22a viewed along an axis parallel to the main extension plane of the bow handle 22a in an actuated state of the control element 64a is preferably between 50 mm and 60 mm, preferably 55 mm. A maximum handle diameter of the bow handle 22a viewed along an axis parallel to the main extension plane of the bow handle 22a in an unactuated state of the control element 64a is preferably between 60 mm and 70 mm, particularly preferably 65 mm. The maximum handle diameter of the bow handle 22a viewed along the axis parallel to the main extension plane of the bow handle 22a in an actuated and/or in an unactuated state of the control element 64a is preferably measured viewed along a direction perpendicular to the central fiber of the bow handle 64a. The maximum handle diameter of the bow handle 22a viewed along the direction parallel to the main extension plane of the bow handle 22a in an actuated and/or in an unactuated state of the control element 64a extends from a gripping surface 60a of the bow handle 22a facing the handle housing 20a, in particular the handle housing base body 120a, preferably a surface of the control element 64a, to a gripping surface of the bow handle 22a facing away from the handle housing 20a, in particular the handle housing base body 120a.

A maximum handle diameter of the bow handle 22a viewed along a direction perpendicular to the main extension plane of the bow handle 22a is preferably between 35 mm and 45 mm, preferably 42 mm. The maximum handle diameter of the bow handle 22a viewed along the direction perpendicular to the main extension plane of the bow handle 22a is measured viewed along a direction perpendicular to the central fiber. The maximum handle diameter of the bow handle 22a viewed along the direction perpendicular to the main extension plane of the bow handle 22a is a spacing of two gripping surfaces of the bow handle 22a which face away from one another.

The bow handle 22a comprises at least one handle portion 146a having a perimeter, which in particular extends in a plane perpendicular to the central fiber 152a of the bow handle 22a, between 140 mm and 170 mm, preferably between 150 mm and 160 mm and particularly preferably 155 mm. The bow handle 22a comprises at least one further handle portion 148a having a perimeter, which in particular extends in a plane perpendicular to the central fiber 152a of the bow handle 22a, between 150 mm and 180 mm, preferably between 160 mm and 170 mm and particularly preferably 166 mm. The further handle portion 148a is disposed such that, viewed along the direction parallel to the axis of rotation 30a starting from the motor housing 24a, it follows the handle portion 146a. Alternatively, however, it is also conceivable that the housing apparatus 18a has other dimensions, in particular depending on the maximum longitudinal extension 110a of the housing apparatus 18a.

The bow handle 22a has a maximum handle length of at least 250 mm. The maximum handle length is measured along the central fiber 152a of the bow handle 22a. The maximum handle length of the bow handle 22a is at most 350 mm. The maximum handle length of the bow handle 22a is preferably between 280 mm and 320 mm, particularly preferably between 295 mm and 315 mm. Viewed along the central fiber 152a, the bow handle 22a is delimited on both sides by the handle housing base body 120a. In particular viewed along the central fiber 152a of the bow handle 22a, the bow handle 22a extends on both sides to a point at which the bow handle 22a merges into the handle housing base body 120a. A value of the maximum handle length is between 60% and 80% of a value of the maximum longitudinal extension 110a of the housing apparatus 18a. Viewed along the direction parallel to the axis of rotation 30a, the gripping surface 60a of the bow handle 22a comprises at least two gripping surface portions 62a, 104a, which, viewed in the direction perpendicular to the axis of rotation 30a, enclose an angle 180a of at least 70°.

The control element 64a is disposed on a side of the bow handle 22a facing the handle housing 20a, in particular the handle housing base body 120a. However, it is also conceivable that the control element 64a is disposed on a side of the bow handle 22a facing away from the handle housing 20a, in particular the handle housing base body 120a. The control element 64a is disposed on the gripping surface 60a. The control element 64a extends at least partly along the at least two gripping surface portions 62a, 104a. The at least two gripping surface portions 62a, 104a of the gripping surface 60a facing the handle housing 20a, in particular the handle housing base body 120a, each have a tangent, which together enclose an angle of at least 70°. The tangents of the two gripping surface portions 62a, 104a of the gripping surface 60a facing the handle housing 20a, in particular the handle housing base body 120a, extend in the main extension plane of the bow handle 22a. The gripping surface 60a, and in particular the at least two gripping surface portions 62a, 104a, are curved at least in sections viewed along the direction parallel to the axis of rotation 30a. At least one gripping surface portion 62a of the at least two gripping surface portions 62a, 104a extends at least partly on a side of the control element 64a facing the motor housing 24a, at least viewed along the direction parallel to the axis of rotation 30a. Viewed along the direction parallel to the axis of rotation 30a, the gripping surface portion 62a extends from an end of the bow handle 22a that is in particular delimited by the handle housing base body 120a, preferably from a point of intersection of the gripping surface 60a with the handle housing base body 120a, to a midpoint of the control element 64a. At least one further gripping surface portion 104a of the at least two gripping surface portions 62a, 104a is disposed at least partly on a side of the control element 64a facing away from the motor housing 24a, at least viewed along the direction parallel to the axis of rotation 30a. Viewed along the direction parallel to the axis of rotation 30a, the further gripping surface portion 104a extends from an end of the bow handle 22a that is in particular delimited by the handle housing base body 120a, preferably from a point of intersection of the gripping surface 60a with the handle housing base body 120a, to a midpoint of the control element 64a. The control element 64a comprises a central fiber 150a. The midpoint of the control element 64a is disposed on the central fiber 150a of the control element 64a, in particular in the middle along the maximum longitudinal extension of the control element 64a. The at least two gripping surface portions 62a, 104a are disposed adjacent to one another. At least viewed along the direction parallel to the axis of rotation 30a, a transition between the at least two gripping surface portions 62a, 104a is continuous, in particular without steps. Alternatively, it is also conceivable that the two gripping surface portions 62a, 104a adjoin one another such that at least one step is formed between the two gripping surface portions 62a, 104a, at least viewed along the direction parallel to the axis of rotation 30a. Viewed along the central fiber 152a of the bow handle 22a, the bow handle 22a has a curved profile at least in sections. Alternatively or additionally, it is also conceivable that, viewed along the central fiber 152a of the bow handle 22a, the bow handle 22a has a stepped and/or a straight profile at least in sections.

The gripping surface portion 62a of the gripping surface 60a of the bow handle 22a encloses an angle with a value between 40° and 50° with an axis which extends parallel to the axis of rotation 30a. The gripping surface portion 62a has at least one tangent, which extends in the main extension plane of the bow handle 22a and encloses an angle with a value between 40° and 500 with the axis of rotation 30a. The bow handle 22a is configured on the gripping surface portion 62a that encloses an angle between 40° and 50° with an axis which extends parallel to the axis of rotation 30a, such that a user can grasp the bow handle 22a at the gripping surface portion 62a in such a way that a grip axis of a user's hand encloses an angle between 40° and 50° with the axis of rotation 30a. The further gripping surface portion 104a of the gripping surface 60a of the bow handle 22a encloses an angle with a value between 90° and 120° with an axis which extends parallel to the axis of rotation 30a. The further gripping surface portion 104a has at least one tangent, which extends in the main extension plane of the bow handle 22a and encloses an angle with a value between 90° and 120° with the axis of rotation 30a. The bow handle 22a is configured on the further gripping surface portion 104a that encloses an angle with a value between 90° and 120° with the axis of rotation 30a such that a user can grasp the bow handle 22a at the further gripping surface portion 104a in such a way that a grip axis of a user's hand encloses an angle with a value between 90° and 120° with the axis of rotation 30a.

Viewed along the maximum handle length of the bow handle 22a, the control element 64a is disposed in a central region of the bow handle 22a. A maximum longitudinal extension of the control element 64a is preferably measured along the central fiber 150a of the control element 64a. Viewed along the direction parallel to the axis of rotation 30a, the control element 64a, in particular the central fiber 150a of the control element 64a, has a curved profile at least in sections. Alternatively or additionally, it is also conceivable that the central fiber 150a of the control element 64a extends at least partly at an angle and/or in a straight line, at least viewed along the direction parallel to the axis of rotation 30a. The central fiber 150a of the control element 64a is at least substantially parallel to the central fiber 152a of the bow handle 22a. The central region of the bow handle 22a extends around a midpoint of the bow handle 22a, at least viewed along the central fiber 152a of the bow handle 22a. A value of a maximum extension of the central region of the bow handle 22a along the central fiber 152a of the bow handle 22a starting from the midpoint of the bow handle 22a is preferably at least 20% of a value of a maximum handle length of the bow handle 22a, preferably on a side of the midpoint of the bow handle 22a facing and/or facing away from the motor housing 24a. A value of the maximum extension of the central region of the bow handle 22a along the central fiber 152a of the bow handle 22a starting from the midpoint of the bow handle 22a is at most 40%, particularly preferably at most 30%, of a value of the maximum handle length of the bow handle 22a, preferably on a side of the midpoint of the bow handle 22a facing and/or facing away from the motor housing 24a. The maximum extension of the central region of the bow handle 22a along the central fiber 152a of the bow handle 22a starting from the midpoint of the bow handle 22a is between 50 mm and 120 mm, particularly preferably between 60 mm and 90 mm, in particular on a side of the midpoint of the bow handle 22a facing and/or facing away from the motor housing 24a. A value of a maximum extension of the central region of the bow handle 22a along a direction perpendicular to the central fiber 152a of the bow handle 22a starting from the central fiber 150a is between 5% and 15% of a value of the maximum handle length of the bow handle 22a. The maximum extension of the central region of the bow handle 22a along the direction perpendicular to the central fiber 152a of the bow handle 22a starting from the central fiber 152a is between 25 mm and 35 mm.

On a side of the battery pack interface 40a facing away from the motor housing 24a, the handle housing 20a comprises a battery protection wall 82a. The battery protection wall 82a has a maximum extension 114a along the direction perpendicular to the axis of rotation 30a starting from the axis of rotation 30a that corresponds to more than 25% of the maximum extension 116a of the motor housing 24a along the direction perpendicular to the axis of rotation 30a starting from the axis of rotation 30a. The maximum extension 114a of the battery protection wall 82a along the direction perpendicular to the axis of rotation 30a starting from the axis of rotation 30a extends from the axis of rotation 30a along the direction perpendicular to the axis of rotation 30a to a point of a surface of the battery protection wall 82a furthest from the axis of rotation 30a. Viewed along the direction perpendicular to the axis of rotation 30a, a value of the maximum extension 114a of the battery protection wall 82a starting from the axis of rotation 30a is less than 120% of a value of the maximum extension 116a of the motor housing 24a along the direction perpendicular to the axis of rotation 30a starting from the axis of rotation 30a. Viewed along the direction perpendicular to the axis of rotation 30a, a value of the maximum extension 114a of the battery protection wall 82a starting from the axis of rotation 30a is less than 50% of a value of the maximum extension 116a of the motor housing 24a starting from the axis of rotation 30a viewed along the direction perpendicular to the axis of rotation 30a. The battery protection wall 82a comprises a surface 106a which faces the battery pack interface 40a and extends at least substantially perpendicular to the axis of rotation 30a.

Viewed along the direction parallel to the axis of rotation 30a, the bow handle 22a at least partly covers the battery protection wall 82a on a side of the battery protection wall 82a facing away from the motor housing 24a. The bow handle 22a is disposed on the battery protection wall 82a at least partly on a side of the battery protection wall 82a facing away from the battery pack interface 40a. The battery protection wall 82a is formed by the handle housing base body 120a. A value of a maximum extension 156a of the bow handle 22a starting from the axis of rotation 30a viewed along the perpendicular to the axis of rotation 30a on a side of the axis of rotation 30a facing the battery protection wall 82a corresponds at least substantially to a value of the maximum extension 114a of the battery protection wall 82a starting from the axis of rotation 30a viewed along the direction perpendicular to the axis of rotation 30a. Viewed along the direction perpendicular to the axis of rotation 30a, the maximum extension 156a of the bow handle 22a starting from the axis of rotation 30a extends on the side of the axis of rotation 30a facing the battery protection wall 82a to a point of a surface of the bow handle 22a furthest away from the axis of rotation 30a. It is also conceivable that a value of the maximum extension 156a of the bow handle 22a starting from the axis of rotation 30a on the side of the axis of rotation 30a facing the battery protection wall 82a viewed along the direction perpendicular to the axis of rotation 30a on the side of the axis of rotation 30a facing the battery protection wall 82a is smaller or greater than a value of the maximum extension 114a of the battery protection wall 82a starting from the axis of rotation 30a viewed along the direction perpendicular to the axis of rotation 30a.

The handle housing 20a comprises a further battery protection wall 84a opposite to the battery protection wall 82a. The further battery protection wall 84a is disposed on a side of the battery pack interface 40a facing the motor housing 24a. The further battery protection wall 84a comprises at least one surface 108a which faces the battery pack interface 40a and extends at least substantially perpendicular to the axis of rotation 30a. The surface 106a of the battery protection wall 82a facing the battery pack interface 40a extends at least substantially parallel to the surface 108a of the further battery protection wall 84a facing the battery pack interface 40a. The battery protection wall 82a and the further battery protection wall 84a are connected via a lower outer wall 158a of the handle housing 20a, in particular the handle housing base body 120a. The lower outer wall 158a is disposed on a side of the handle housing 20a, in particular the handle housing base body 120a, facing away from the bow handle 22a. The lower outer wall 158a extends at least substantially perpendicular to the surface 106a of the battery protection wall 82a facing the battery pack interface 40a and/or the surface 108a of the further battery protection wall 84a facing the battery pack interface 40a. The battery protection wall 82a, the further battery protection wall 84a and/or the lower outer wall 158a at least partly delimit a battery pack placement region of the battery pack interface 40a.

The further battery protection wall 84a has a maximum extension 118a starting from the axis of rotation 30a and extending along the direction perpendicular to the axis of rotation 30a, the value of which is at least 80% of a value of the maximum extension 114a of the battery protection wall 82a. A value of the maximum extension 118a of the further battery protection wall 84a is equal to or greater than a value of the maximum extension 114a of the battery protection wall 82a. The maximum extension 118a of the further battery protection wall 84a starting from the axis of rotation 30a along the direction perpendicular to the axis of rotation 30a extends on a side of the axis of rotation 30a facing the further battery protection wall 84a from the axis of rotation 30a along the direction perpendicular to the axis of rotation 30a to a point of a surface of the further battery protection wall 84a furthest away from the axis of rotation 30a. A value of the maximum extension 114a of the battery protection wall 82a starting from the axis of rotation 30a along the direction perpendicular to the axis of rotation 30a is at most 50% of a value of the maximum extension 118a of the further battery protection wall 84a starting from the axis of rotation 30a viewed along the direction perpendicular to the axis of rotation 30a.

In a state in which the battery packs are disposed on the battery pack interface 40a, the battery protection wall 82a of the handle housing 20a covers at least 25% of the two battery packs 14a, 16a on a side of the two battery packs 14a, 16a facing away from the motor housing 24a. The battery protection wall 82a is disposed on a side of the battery packs 14a, 16a disposed on the battery pack interface 40a facing away from motor housing 24a. The hand-held power tool system 10a comprises at least one removed material protection unit 88a which is provided to protect at least one of the two battery packs 14a, 16a in a state in which the battery packs are disposed on the battery pack interface 40a from removed material, in particular flying sparks, produced by machining a workpiece using the hand-held power tool 12a. It is conceivable that the removed material protection unit 88a is provided to protect a gripping region of the bow handle 22a, and thus in particular a user, preferably a hand of the user that grips the bow handle 22a on the gripping region, from removed material, in particular flying sparks, for example when working with the hand-held power tool 12a. The handle housing 20a and/or battery pack interface 40a are/is configured such that, between a battery pack 14a of the two battery packs 14a, 16a in a state in which the battery pack 14a is disposed on the battery pack interface 40a, a gap 90a is formed between the battery pack 14a and the handle housing 20a, in particular handle housing base body 120a, in which a removed material protection element 86a, in particular a spark protection element, is disposed. The at least one removed material protection element 86a is part of the removed material protection unit 88a, for instance.

The gap 90a is disposed at least on the side of the battery pack interface 40a facing the motor housing 24a. The gap 90a is formed between the further battery protection wall 84a and the battery pack 14a in a state in which the battery pack 14a is disposed on the battery pack interface 40a. The further battery protection wall 84a comprises two surfaces 108a, 160a which are offset to one another, in particular the previously already mentioned surface 108a and a further surface 160a facing the battery pack interface 40a. The two surfaces 108a, 160a are offset to one another viewed along the direction parallel to the axis of rotation 30a. Alternatively, it is also conceivable that the further battery protection wall 84a is configured free of surfaces which are offset to one another. The gap 90a is formed between the surface 108a of the further battery protection wall 84a, which is in particular further away from the axis of rotation 30a viewed along the direction perpendicular to the axis of rotation 30a than the further surface 160a of the further battery protection wall 84a, and the battery pack 14a disposed at the battery pack interface 40a. The removed material protection element 86a which is configured as a spark protection element is configured as a protective plate, for example. It is also conceivable that the removed material protection element 86a is configured as another removed material protection element 86a deemed appropriate by those skilled in the art. It is also conceivable that the removed material protection element 86a is disposed on the handle housing 20a such that it can removed, preferably without the need for tools and/or non-destructively. A maximum spacing of the removed material protection element 86a in a state in which the removed material protection element 86a is disposed in the gap 90a to the axis of rotation 30a viewed along the direction perpendicular to the axis of rotation 30a is greater than the maximum extension 114a,116a of the battery protection wall 82a and/or the further battery protection wall 84a starting from the axis of rotation 30a viewed along the direction perpendicular to the axis of rotation 30a. The maximum spacing of the removed material protection element 86a to the axis of rotation 30a viewed along the direction perpendicular to the axis of rotation 30a is greater than the maximum extension 116a of the motor housing 24a starting from the axis of rotation 30a viewed along the direction perpendicular to the axis of rotation 30a. The maximum spacing of the removed material protection element 86a to the axis of rotation 30a viewed along the direction perpendicular to the axis of rotation 30a extends from the axis of rotation 30a along the direction perpendicular to the axis of rotation 30a to a point of a surface of the removed material protection element 86a furthest away from the axis of rotation 30a.

The removed material protection unit 88a is formed at least in part by the battery pack 14a, in particular by the battery pack 14a of the two battery packs 14a, 16a disposed closer to the motor housing 24a, at least viewed along the direction parallel to the axis of rotation 30a. Another battery pack 16a of the two battery packs 14a, 16a, which is disposed behind the battery pack 14a, in particular starting from the motor housing 24a viewed along the direction parallel to the axis of rotation 30a, is at least partly, particularly preferably entirely, covered by the battery pack 14a viewed along the direction parallel to the axis of rotation 30a. The handle housing 20a is configured such that at least 25% of the two battery packs 14a, 16a is covered on both sides by the handle housing 20a in a state in which the battery packs are disposed on the battery pack interface 40a, at least viewed along the direction parallel to the axis of rotation 30a. In particular at least part, preferably at least 25%, of the two battery packs 14a, 16a is covered by the battery protection wall 82a and the further battery protection wall 84a viewed along the direction parallel to the axis of rotation 30a.

The housing apparatus 18a comprises at least one cooling unit 32a for cooling an interior space 34a of the motor housing 24a and/or for cooling an interior space 178a of the handle housing 20a. The cooling unit 32a is disposed at least partly opposite to the bow handle 22a on the handle housing 20a, in particular the handle housing base body 120a. The handle housing 20a comprises a cooling air inlet region 36a. The cooling air inlet region 36a faces the bow handle 22a. The cooling unit 32a comprises ventilation openings 38a disposed at the cooling air inlet region 36a. The cooling air inlet region 36a is disposed at least substantially entirely, in particular within a space defined by the handle housing 20a, between the axis of rotation 30a and the bow handle 22a, in particular at least viewed along the direction perpendicular to the axis of rotation 30a. Viewed along the direction perpendicular to the axis of rotation 30a, the cooling air inlet region 36a is disposed entirely between the axis of rotation 30a and the bow handle 22a. The cooling air inlet region 36a is defined by ventilation openings 38a of the cooling unit 32a. The ventilation openings 38a of the cooling unit 32a, which define the cooling air inlet region 36a, are disposed opposite to the bow handle 22a on the handle housing 20a, in particular on the handle housing base body 120a of the handle housing 20a. The cooling air inlet region 36a is provided to admit ambient air into the handle housing 20a and/or the motor housing 24a. It is conceivable that the housing apparatus 18a and/or the hand-held power tool 12a comprises a flow machine (not shown here), for example, a fan, that is provided to draw ambient air into the handle housing 20a and/or the motor housing 24a via the cooling air inlet region 36a, in particular via the ventilation openings 38a of the cooling unit 32a, which in particular define the cooling air inlet region 36a. The ventilation openings 38a of the cooling unit 32a which define the cooling air inlet region 36a are disposed at least substantially entirely between the axis of rotation 30a and the bow handle 22a, at least viewed along the direction perpendicular to the axis of rotation 30a. The cooling unit 32a comprises a plurality of ventilation openings 38a which define the cooling air inlet region 36a. The ventilation openings 38a of the plurality of ventilation openings 38a which define the cooling air inlet region 36a are disposed on the handle housing 20a spaced apart from one another. Alternatively, however, it is also conceivable that the cooling unit 32a comprises only one ventilation opening 38a that defines the cooling air inlet region 36a. The ventilation openings 38a of the cooling unit 32a which define the cooling air inlet region 36a are formed by recesses in the handle housing 20a, in particular in the handle housing base body 120a. The outer wall 50a of the handle housing 20a, in particular the handle housing base body 120a, is the outer wall of the handle housing 20a that is furthest away from the axis of rotation 30a, at least viewed along the direction perpendicular to the axis of rotation 30a. A value of a minimum spacing of the axis of rotation 30a to at least one of the ventilation openings 38a which at least partly defines the cooling air inlet region 36a viewed along the direction perpendicular to the axis of rotation 30a is greater than a value of the maximum extension 116a of the motor housing 24a starting from the axis of rotation 30a viewed along the direction perpendicular to the axis of rotation 30a. The minimum spacing of the axis of rotation 30a to at least one of the ventilation openings 38a which in particular at least partly defines the cooling air inlet region 36a viewed along the direction perpendicular to the axis of rotation 30a extends from the axis of rotation 30a viewed along the direction perpendicular to the axis of rotation 30a to a portion of the at least one ventilation opening 38a closest to the axis of rotation 30a. Alternatively or additionally, however, it is also conceivable that a value of the minimum spacing of the axis of rotation 30a to at least one of the ventilation openings 38a which at least partly defines the cooling air inlet region 36a viewed along the direction perpendicular to the axis of rotation 30a is equal to or smaller than a value of the maximum extension 116a of the motor housing 24a starting from the axis of rotation 30a viewed along the direction perpendicular to the axis of rotation 30a.

The cooling air inlet region 36a is disposed on a side of the handle housing 20a facing away from the battery pack interface 40a. The cooling air inlet region 36a is disposed at least substantially entirely between the bow handle 22a and the battery pack interface 40a, at least viewed along the direction perpendicular to the axis of rotation 30a.

The battery pack interface 40a is disposed in an immediate vicinity of the cooling air inlet region 36a. An axis which extends perpendicular to the axis of rotation 30a intersects the cooling air inlet region 36a and the battery pack interface 40a. At least viewed along a direction parallel to the output axis 80a and/or perpendicular to the axis of rotation 30a, the battery pack interface 40a extends at least substantially entirely over the cooling air inlet region 36a, in particular the ventilation openings 38a of the cooling unit 32a which define the cooling air inlet region 36a. The immediate vicinity of the cooling air inlet region 36a has a maximum extension starting from the cooling air inlet region 36a, in particular the ventilation openings 38a of the cooling unit 32a which define the cooling air inlet region 36a, along the direction perpendicular to the axis of rotation 30a, the value of which is at most 10% of a value of the maximum longitudinal extension 110a of the housing apparatus 18a and/or corresponds at most to a value of the maximum extension 116a of the motor housing 24a starting from the axis of rotation 30a and extending perpendicular to the axis of rotation 30a. The maximum extension of the immediate vicinity of the cooling air inlet region 36a starting from the cooling air inlet region 36a, in particular from the ventilation openings 38a which define the cooling air inlet region 36a, and extending perpendicular to the axis of rotation 30a is less than or equal to 45 mm. The axis of rotation 30a intersects the battery pack interface 40a. The battery pack interface 40a is disposed at least partly between the axis of rotation 30a and the cooling air inlet region 36a. At least viewed along the direction perpendicular to the axis of rotation 30a, a minimum spacing of the battery pack interface 40a to the cooling air inlet region 36a is preferably at most 10% of a value of the maximum longitudinal extension 110a of the housing apparatus 18a. The minimum spacing of the battery pack interface 40a to the cooling air inlet region 36a extends from a portion of the battery pack interface 40a closest to the cooling air inlet region 36a viewed along the direction perpendicular to the axis of rotation 30a, to a portion of the cooling air inlet region 36a closest to the battery pack interface 40a, in particular the closest ventilation opening 38a of the cooling unit 32a which at least partly defines the cooling air inlet region 36a. At least viewed along the direction perpendicular to the axis of rotation 30a, a value of the minimum spacing of the battery pack interface 40a to the cooling air inlet region 36a is at most a value of the maximum extension 116a of the motor housing 24a starting from the axis of rotation 30a along the direction perpendicular to the axis of rotation 30a. A value of the minimum spacing of the battery pack interface 40a to the cooling air inlet region 36a, in particular the ventilation openings 38 of the cooling unit 32a which define the cooling air inlet region 36a, is less than or equal to 45 mm viewed along the direction perpendicular to the axis of rotation 30a.

The cooling air inlet region 36a is disposed at least partly between the hand-held power tool electronics 46a and the bow handle 22a, at least viewed along the direction perpendicular to the axis of rotation 30a. The cooling air inlet region 36a is disposed at least substantially entirely between the hand-held power tool electronics 46a and the bow handle 22a. The hand-held power tool electronics 46a are disposed at least substantially entirely between the axis of rotation 30a and the bow handle 22a, at least viewed along the direction perpendicular to the axis of rotation 30a. The hand-held power tool electronics 46a are disposed at least substantially entirely between the axis of rotation 30a and the cooling air inlet region 36a, at least viewed along the direction perpendicular to the axis of rotation 30a. One axis, in particular the previously already mentioned axis which extends perpendicular to the axis of rotation 30a, intersects the cooling air inlet region 36a and the hand-held power tool electronics 46a. At least viewed along the direction perpendicular to the axis of rotation 30a, the hand-held power tool electronics 46a extend at least substantially entirely over the cooling air inlet region 36a. The hand-held power tool electronics 46a are disposed at least substantially entirely between the battery pack interface 40a and the cooling air inlet region 36a, in particular at least viewed along the direction perpendicular to the axis of rotation 30a.

The cooling unit 32a comprises at least one air routing extension 42a, which is provided within the handle housing 20a for routing air of at least one air admitted into the handle housing 20a via the cooling air inlet region 36a. The air routing extension 42a at least partly delimits an air duct 44a of the cooling unit 32a. The air routing extension 42a is provided to route admitted air at least in the direction of the motor housing 24a and/or the battery pack interface 40a. A free end 162a of the air routing extension 42a delimits an outlet of the air duct 44a. The outlet of the air duct 44a is directed in the direction of the motor housing 24a and/or the battery pack interface 40a. The air routing extension 42a is disposed on the outer wall 50a of the handle housing 20a, in particular the handle housing base body 120a, on which the ventilation openings 38a of the cooling unit 32a which define the cooling air inlet region 36a are disposed, in particular on a side of the outer wall 50a facing away from the bow handle 22a. The air duct 44a comprises one or more inlets, for instance. The inlet or the plurality of inlets of the air duct 44a are formed by at least a portion of the ventilation openings 38a of the cooling unit 32a which define the cooling air inlet region 36a. The air duct 44a is delimited at least partly by the outer wall 50a of the handle housing 20a, in particular the handle housing base body 120a. A value of a minimum spacing of the air routing extension 42a to the motor housing 24a viewed along the direction parallel to the axis of rotation 30a is at most 1% of a value of the maximum longitudinal extension 110a of the housing apparatus 18a. The minimum spacing of the air routing extension 42a to the motor housing 24a viewed along the direction parallel to the axis of rotation 30a extends from a point of a surface of the motor housing 24a closest to the air routing extension 42a viewed along the direction parallel to the axis of rotation 30a to a point of a surface of the air routing extension 42a closest to the motor housing 24a. The minimum spacing of the air routing extension 42a to the motor housing 24a is between 2 mm and 6 mm, particularly preferably between 3 and 4 mm. Alternatively, however, it is also conceivable that the air routing extension 42a projects at least partly into the motor housing 24a, at least viewed along the direction parallel to the axis of rotation 30a.

The air routing extension 42a has curved profile at least in sections. At least viewed along the direction parallel to the axis of rotation 30a, the air routing extension 42a has a curved profile at least in sections. A profile of the air routing extension 42a viewed along the direction parallel to the axis of rotation 30a is at least substantially entirely without steps. Particularly preferably, at least 90% of a profile of the air routing extension 42a viewed along the direction parallel to the axis of rotation 30a is without steps. A value of a minimum spacing of the cooling air inlet region 36a to the drive unit 28a viewed along the direction parallel to the axis of rotation 30a is at most 25% of a value of the maximum hand-held power tool longitudinal extension 100a. The minimum spacing of the cooling air inlet region 36a to the drive unit 28a viewed along the direction parallel to the axis of rotation 30a extends from a point of a surface of the drive unit 28a closest to the cooling air inlet region 36a viewed along the direction parallel to the axis of rotation 30a to a portion of the cooling air inlet region 36a closest to the drive unit 28a, in particular the closest ventilation opening 38a of the cooling unit 36a which at least partly defines the cooling air inlet region 36a. The minimum spacing of the cooling air inlet region 36a to the drive unit 28a viewed along the direction parallel to the axis of rotation 30a is at most 100 mm, particularly preferably at most 90 mm.

The air routing extension 42a is disposed at least partly between the hand-held power tool electronics 46a and the drive unit 28a. The free end 162a of the air routing extension 42a is disposed between the drive unit 28a and the hand-held power tool electronics 46a, at least viewed along the direction parallel to the axis of rotation 30a. A value of a minimum spacing of the air routing extension 42a to the drive unit 28a viewed along the direction parallel to the axis of rotation 30a is at most 10% of a value of the maximum hand-held power tool longitudinal extension 100a. The minimum spacing of the air routing extension 42a to the drive unit 28a viewed along the direction parallel to the axis of rotation 30a extends from a point of a surface of the drive unit 28a closest to the air routing extension 42a viewed along the direction parallel to the axis of rotation 30a to a point of a surface of the air routing extension 42a closest to the drive unit 28a. The minimum spacing of the air routing extension 42a to the drive unit 28a viewed along the direction parallel to the axis of rotation 30a is between 30 mm and 40 mm.

The hand-held power tool electronics 46a comprise at least one cooling fin 56a which projects at least partly into the air duct 44a of the cooling unit 32a. The cooling fin 56a is disposed on a side of the hand-held power tool electronics 46a facing the cooling air inlet region 36a and/or the bow handle 22a. The cooling fin 56a extends at least substantially entirely over the other components of the hand-held power tool electronics 46a, at least viewed along the direction perpendicular to the axis of rotation 30a. The cooling fin 56a, in particular a surface of the cooling fin 56a facing the cooling air inlet region 36a, is disposed at least substantially entirely within the air duct 44a of the cooling unit 32a.

The hand-held power tool 12a comprises at least one electrical connecting element 66a for electrically connecting the drive unit 28a to the hand-held power tool electronics 46a and/or the battery pack interface 40a. The electrical connecting element 66a has an excess length at the pivot joint 68a of the housing apparatus 18a in order to enable rotation of the handle housing 20a relative to the motor housing 24a. The electrical connecting element 66a is configured as a cable or the like. The electrical connecting element 66a is configured such that the excess length enables rotation of the motor housing 24a relative to the handle housing 20a by at least 90°, in particular without damaging the electrical connecting element 66a and/or releasing a point of contact with the drive unit 28a, the hand-held power tool electronics 46a and/or the battery pack interface 40a. Alternatively, it is also conceivable that the hand-held power tool 12a comprises a sliding contact unit, which comprises at least one slip ring, for example, in particular in the region of the pivot joint 68a, or the like, for electrically connecting the drive unit 28a to the hand-held power tool electronics 46a and/or the battery pack interface 40a.

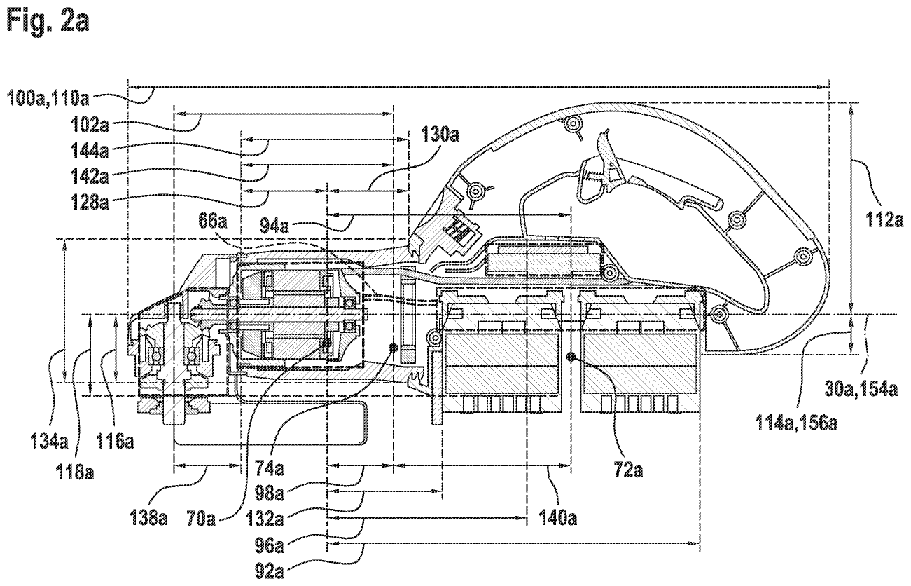

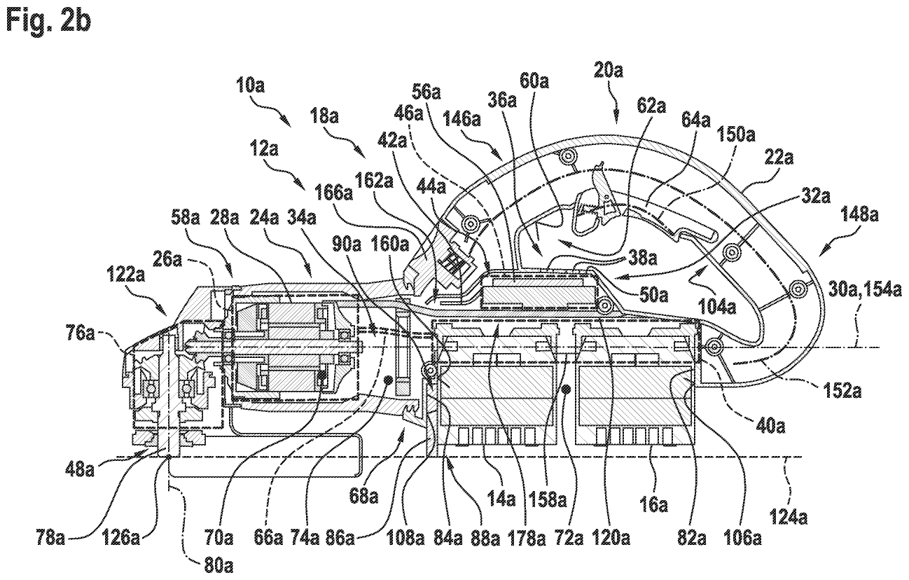

The housing apparatus 18a of the hand-held power tool 12a configured as angle grinder has at least two different operating positions. One of the two operating positions, in which the insert tool holder 48a is disposed on a side of the handle housing 20a facing away from the bow handle 22a, is the grinding and/or roughing position. Another of the two operating positions, in which the insert tool holder 48a is preferably rotated 90° about the rotary axis 154a of the pivot joint 68a to the grinding and/or roughing position, is a cutting position. The hand-held power tool 12a of FIGS. 1 and 2 is in the grinding and/or roughing position. At least in the grinding and/or roughing position, the output axis 80a extends in the main extension plane of the bow handle 22a. In the cutting position, the output axis 80a extends at least substantially perpendicular to the main extension plane of the bow handle 22a. FIGS. 1 and 2 show the hand-held power tool system 10a viewed along the direction perpendicular to the axis of rotation 30a.

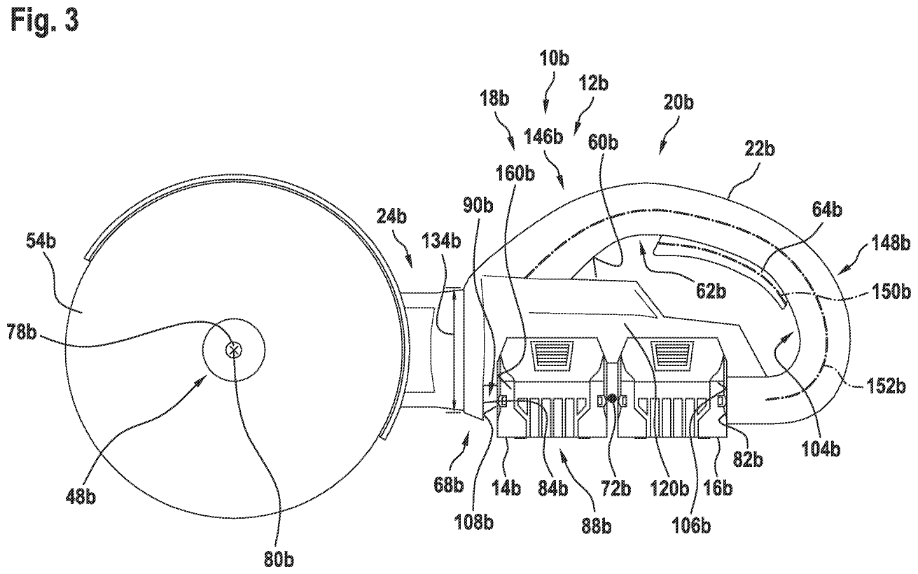

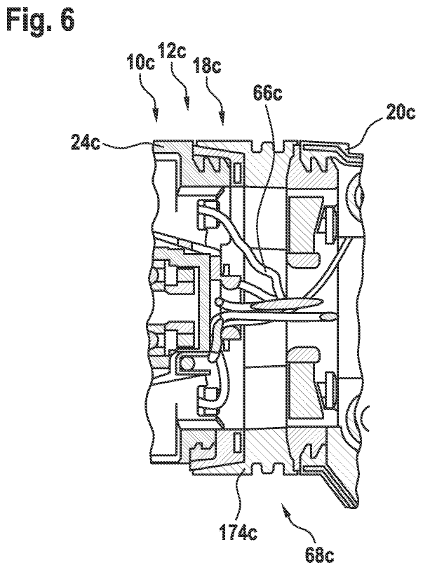

FIGS. 3 to 6 show further embodiment examples of the invention. The following descriptions and the drawings are limited substantially to the differences between the embodiment examples, wherein with respect to identically labeled components, in particular with respect to components having identical reference signs, reference can in principle also be made to the drawings and/or the description of the other embodiment examples, in particular of FIGS. 1 and 2. To distinguish the embodiment examples, the letter a is added to the reference signs of the embodiment example in FIGS. 1 and 2. In the embodiment examples of FIGS. 3 to 6, the letter a is replaced by the letters b and c.

FIG. 3 shows a hand-held power tool system 10b comprising a hand-held power tool 12b. The hand-held power tool system 10b comprises two battery packs 14b, 16b. Alternatively, it is also conceivable that the hand-held power tool system 10b comprises only one battery pack or more than two battery packs. The hand-held power tool 12b is configured as an angle grinder. Alternatively, it is also conceivable that the hand-held power tool 12b is configured as another hand-held power tool 12b deemed appropriate by those skilled in the art, for example as a drill, as a hammer drill and/or chisel hammer, as a reciprocating saw, as a power saw or the like. The hand-held power tool 12b comprises at least one drive unit 28b. The hand-held power tool 12b comprises at least one housing apparatus 18b.

The housing apparatus 18b comprises at least one handle housing 20b comprising at least one bow handle 22b. The housing apparatus 18b comprises at least one motor housing 24b comprising at least one storage area 26b in which the drive unit 28b can be disposed. The storage area 26b defines an orientation of an axis of rotation 30b of the drive unit 28b. Viewed along a direction parallel to the axis of rotation 30b, the handle housing 20b, in particular the bow handle 22b, is disposed on the motor housing 24b at least substantially entirely on a gearbox housing connection region 58b of the motor housing 24b. The housing apparatus 18b comprises at least one battery pack interface 40b for placement of the two battery packs 14b, 16b, which is disposed on the handle housing 20b on a side of the handle housing 20b facing away from the bow handle 22b, in particular a handle housing base body 120b. The battery pack interface 40b is disposed in an immediate vicinity of the axis of rotation 30b.

The hand-held power tool 12b comprises at least one insert tool holder 48b for placement of an insert tool 54b. In at least one operating state, the insert tool holder 48b is disposed on a gearbox housing 122b of the housing apparatus 18b on a side of the handle housing 20b, in particular the handle housing base body 120b, facing away from the bow handle 22b. The insert tool 54b is configured as a grinding wheel or a cutting wheel. Alternatively, however, it is also conceivable that the insert tool 54b is configured as another insert tool 54b deemed appropriate by those skilled in the art, in particular depending on a design of the hand-held power tool 12b. A maximum diameter of an insert tool 54b configured as a cutting wheel or grinding wheel is 180 mm or 230 mm, for example. However, other values for the maximum diameter are alternatively conceivable as well.

The bow handle 22b comprises at least one control element 64b, which, viewed along a maximum handle length of the bow handle 22b, is disposed in a central region of the bow handle 22b, wherein a value of a maximum longitudinal extension of the control element 64b is at least 20% of a value of the maximum handle length of the bow handle 22b. A value of the maximum longitudinal extension of the control element 64b is particularly preferably at least 30% of a value of the maximum handle length of the bow handle 22b. A value of the maximum longitudinal extension of the control element 64b is at most 50%, particularly preferably at most 40%, a value of the maximum handle length of the bow handle 22b. The maximum longitudinal extension of the control element 64b is between 90 mm and 110 mm. However, other dimensions for the control element 64b deemed appropriate by those skilled in the art, in particular relative to the maximum handle length of the bow handle 22b, are alternatively conceivable as well. Alternatively, however, it is also conceivable that the control element 64b has a different value, in particular outside a range between 90 mm and 110 mm, for the maximum longitudinal extension of the control element 64b.

On a side of the battery pack interface 40b facing away from motor housing 24b, the handle housing 20b comprises a battery protection wall 82b which has a maximum extension 114b starting from the axis of rotation 30b along a direction perpendicular to the axis of rotation 30b that corresponds to more than 25% of the maximum extension 116b of the motor housing 24b starting from the axis of rotation 30b along the direction perpendicular to the axis of rotation 30b. A value of the maximum extension 114b of the battery protection wall 82b starting from the axis of rotation 30b along the direction perpendicular to the axis of rotation 30b is more than 50%, preferably more than 90% and particularly preferably more than 100%, of a value of the maximum extension 116b of the motor housing 24b starting from the axis of rotation 30b along the direction perpendicular to the axis of rotation 30b.

The battery protection wall 82b of the handle housing 20b covers the two battery packs 14b, 16b in a state in which the battery packs are disposed on the battery pack interface 40b on a side of the two battery packs 14b, 16b facing away from the motor housing 24b at least largely, in particular at least viewed along the direction parallel to the axis of rotation 30b. The bow handle 22b covers the two battery packs 14b, 16b in a state in which the battery packs are disposed on the battery pack interface 40b on the side of the two battery packs 14b, 16b facing away from the motor housing 24b at least substantially entirely, in particular at least viewed along the direction parallel to the axis of rotation 30b. The handle housing 20b is configured such that the two battery packs 14b, 16b are covered substantially entirely on both sides by the handle housing 20b in a state in which the battery packs are disposed on the battery pack interface 40b, at least viewed along the direction parallel to the axis of rotation 30b. Viewed along the direction parallel to the axis of rotation 30b, the two battery packs 14b, 16b are at least substantially entirely covered by the battery protection wall 82b and a further battery protection wall 84b of the handle housing 20b.

The housing apparatus 18b comprises at least one cooling unit 32b for cooling an interior space 34b of the motor housing 24b and/or for cooling an interior space 178b of the handle housing 20b, which is disposed at least partly opposite to the bow handle 22b on the handle housing 20b, in particular on a handle housing base body 120b of the handle housing 20b. The handle housing 20b comprises a cooling air inlet region 36b that faces the bow handle 22b and on which ventilation openings 38b of the cooling unit 32b are disposed. The cooling air inlet region 36b is disposed at least partly on an outer wall 50b of the handle housing 20b, in particular the handle housing base body 120b, which, at least viewed along the direction perpendicular to the axis of rotation 30b, extends parallel to the axis of rotation 30b. The cooling air inlet region 36b is disposed at least partly on a further outer wall 52b of the handle housing 20b, in particular the handle housing base body 120b, which extends at an angle to the axis of rotation 30b. At least two ventilation openings 38b of the cooling unit 32b are disposed on the cooling air inlet region 36b and are disposed on a side of the handle housing 20a facing away from the insert tool holder 48b on the outer walls 50b, 52b of the handle housing 20a which are angled relative to one another. At least one of the two ventilation openings 38b is disposed on the outer wall 50b of the handle housing 20b, in particular the handle housing base body 120b, which, at least viewed along the direction perpendicular to the axis of rotation 30b, extends parallel to the axis of rotation 30b. The further outer wall 52b of the two outer walls 50b, 52b of the handle housing 20b, in particular of the handle housing base body 120b, on which at least another one of the at least two ventilation openings 38b is disposed, extends relative to the axis of rotation 30b at an angle between 90° and 180°, at least viewed along the direction perpendicular to the axis of rotation 30b. The two outer walls 50b, 52b of the handle housing 20b which are angled relative to one another and on which the at least two ventilation openings 38b are disposed, abut one another. However, it is also conceivable that the two outer walls 50b, 52b of the handle housing 20b which are angled relative to one another and on which the at least two ventilation openings 38b are disposed, are disposed spatially separated from one another. At least one end of a cooling fin 56b of the hand-held power tool electronics 46b of the hand-held power tool 12b facing the motor housing 24b is disposed in an air duct 44b of the cooling unit 32b.

Alternatively, it is also conceivable that the housing apparatus comprises a cooling air inlet region 36b′, which, viewed along the direction parallel to the axis of rotation 30b, is disposed on a side of the handle housing 20b facing away from the motor housing 24b. Viewed along the direction at least substantially parallel to the axis of rotation 30b, the cooling air inlet region 36b′ is disposed on a side of the battery pack interface 40b of the housing apparatus 18b facing away from the motor housing 24b. It is conceivable that ventilation openings (not shown here) of the cooling air inlet region 36b′, in particular viewed along a direction at least substantially perpendicular to the axis of rotation 30b, are disposed on two sides of the handle housing 20b which face away from one another. It is also conceivable that ventilation openings of the cooling air inlet region 36b′, in particular viewed along a direction at least substantially perpendicular to the axis of rotation 30b, are disposed on only one side of the handle housing 20b.

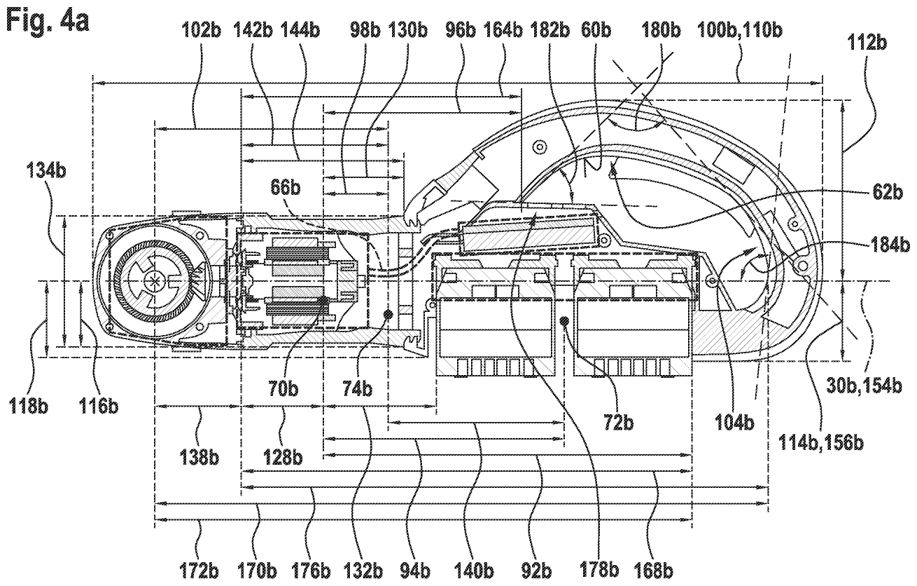

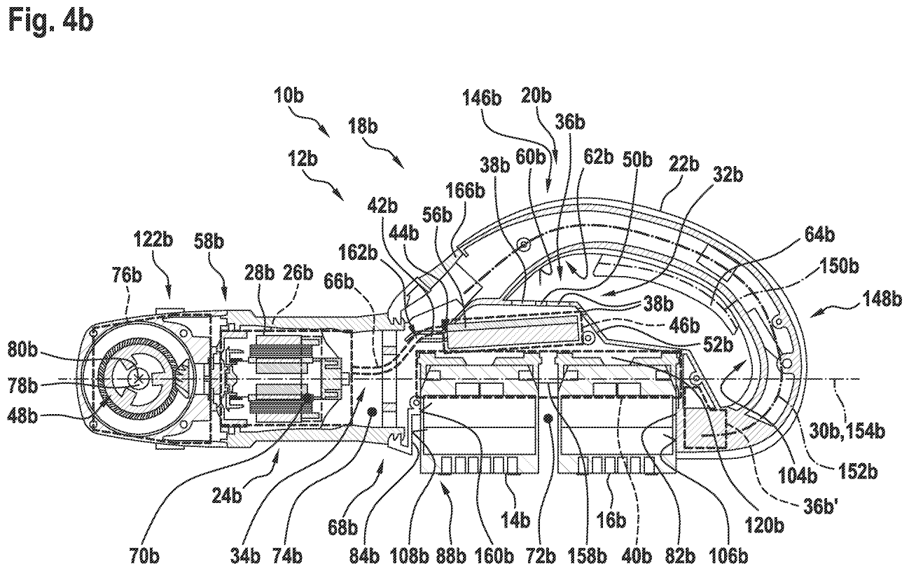

By means of a pivot joint 68b, the motor housing 122b can be rotated relative to the handle housing 20b, preferably by at least 90°. The housing apparatus 18b of the hand-held power tool 12b configured as angle grinder has at least two different operating positions. One of the two operating positions, in which the insert tool holder 48b is disposed on a side of the handle housing 20b facing away from the bow handle 22b, is preferably a grinding and/or roughing position. Another of the two operating positions, in which the insert tool holder 48b is preferably rotated 90° about a rotary axis 154b of the pivot joint 68b to the grinding and/or roughing position, is a cutting position. The hand-held power tool 12b of FIGS. 3 and 4 is in the cutting position. FIGS. 3 and 4 show the hand-held power tool system 10b viewed along the direction perpendicular to the axis of rotation 30b.

The bow handle 22b comprises at least one gripping surface 60b, which in particular faces the handle housing base body 120b. Viewed along the direction parallel to the axis of rotation 30b, the gripping surface 60b of the bow handle 22b comprises at least two gripping surface portions 62b, 104b, which, viewed in the direction perpendicular to the axis of rotation 30b, enclose an angle 180b of at least 70°. A gripping surface portion 62b of the two gripping surface portions 62b, 104b encloses an angle 182b with a value between 40° and 500 with an axis which extends parallel to the axis of rotation 30b. The angle 182b enclosed by the gripping surface portion 62b and the axis which extends parallel to the axis of rotation 30b with a value between 40° and 50° is measured at a point of intersection of the gripping surface portion 62b with the handle housing base body 120b. The angle 182b enclosed by the gripping surface portion 62b and the axis which extends parallel to the axis of rotation 30b is preferably measured on a side of the axis which extends parallel to the axis of rotation 30b that faces away from the handle housing 20b. The gripping surface portion 62b is configured such that, depending on a measuring point, the gripping surface portion 62b, in particular a tangent of the gripping surface portion 62b which preferably extends in a main extension plane of the bow handle 22b, encloses an angle with the axis which extends parallel to the axis of rotation 30b that has a value in an angular range of −40° to 100°. A further gripping surface portion 104b of the two gripping surface portions 62b, 64b encloses an angle 184b with a value between 90° and 120° with the axis of rotation 30b. The angle 184b enclosed by the further gripping surface portion 104b and the axis of rotation 30b is measured at a point of intersection of the further gripping surface portion 104b with the axis of rotation 30b; preferably measured on a side of the axis of rotation 30b facing the control element 64b.

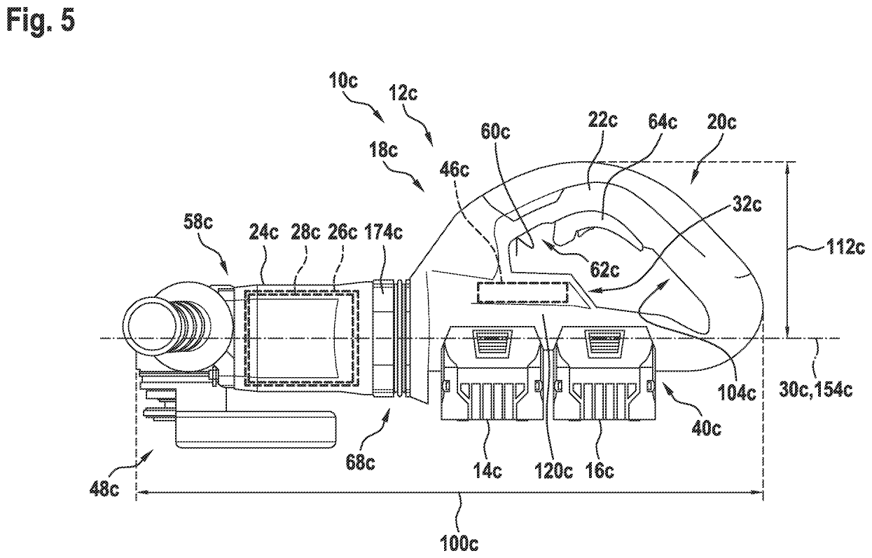

FIG. 5 shows a hand-held power tool system 10c comprising a hand-held power tool 12c. The hand-held power tool system 10c comprises two battery packs 14c, 16c. Alternatively, it is also conceivable that the hand-held power tool system 10c comprises only one battery pack or more than two battery packs. The hand-held power tool 12c is configured as an angle grinder. Alternatively, it is also conceivable that the hand-held power tool 12c is configured as another hand-held power tool 12c deemed appropriate by those skilled in the art, for example as a drill, as a hammer drill and/or chisel hammer, as a reciprocating saw, as a power saw or the like. The hand-held power tool 12c comprises at least one drive unit 28c. The hand-held power tool 12c comprises at least one housing apparatus 18c.

The housing apparatus 18c comprises at least one handle housing 20c comprising at least one bow handle 22c. The housing apparatus 18c comprises at least one motor housing 24c comprising at least one storage area 26c in which the drive unit 28c is disposed. The storage area 26c defines an orientation of an axis of rotation 30c of the drive unit 28c. Viewed along a direction parallel to the axis of rotation 30c, the handle housing 20c, in particular the bow handle 22c, is disposed on the motor housing 24c at least substantially entirely on a gearbox housing connection region 58c of the motor housing 24c. The housing apparatus 18c comprises at least one battery pack interface 40c for placement of the two battery packs 14c, 16c, which is disposed on the handle housing 20c on a side of the handle housing 20c facing away from the bow handle 22c, in particular a handle housing base body 120c. The battery pack interface 40c is disposed in an immediate vicinity of the axis of rotation 30c.

The hand-held power tool 12c comprises at least one insert tool holder 48c for placement of an insert tool (not shown here). In at least one operating state, the insert tool holder 48c is disposed on a gearbox housing 122c of the housing apparatus 18c on a side of the handle housing 20c, in particular the handle housing base body 120c, facing away from the bow handle 22c. The insert tool is configured as a grinding wheel or a cutting wheel. Alternatively, however, it is also conceivable that the insert tool is configured as another insert tool deemed appropriate by those skilled in the art, in particular depending on a design of the hand-held power tool 12c. A maximum diameter of an insert tool configured as a cutting wheel or grinding wheel is 180 mm or 230 mm, for example. However, other values for the maximum diameter are alternatively conceivable as well.

The pivot joint 68c allows the motor housing 24c to be rotatable relative to the handle housing 20c, in particular about a rotary axis 154c of the pivot joint 68c, preferably by at least 90°. The housing apparatus 18c of the hand-held power tool 12c configured as angle grinder has at least two different operating positions. One of the two operating positions, in which the insert tool holder 48c is disposed on a side of the handle housing 20c facing away from the bow handle 22c, is preferably a grinding and/or roughing position. Another of the two operating positions, in which the insert tool holder 48c is preferably rotated 90° about the rotary axis 154c of the pivot joint 68c to the grinding and/or roughing position, is a cutting position. The hand-held power tool 12c of FIG. 5 is in the cutting position. FIG. 5 shows the hand-held power tool system 10c viewed along the direction perpendicular to the axis of rotation 30c.

The housing apparatus 18c comprises a decoupling element 174c to counteract a transmission of vibrations and/or shocks that occur when working with the hand-held power tool 12c as a result of an interaction of the insert tool with a workpiece to a hand of the user on the bow handle 22c. The decoupling element 174c is formed from an elastic material, for example, in particular a rubber-elastic material, preferably as a rubber damper, or the like. The decoupling element 174c is disposed between the motor housing 24c and the handle housing 20c, in particular at the pivot joint 68c. It is conceivable that the pivot joint 68c is formed at least partly by the decoupling element 174c. The decoupling element 174c is fixedly connected to the motor housing 24c, for instance, and mounted such that it is rotatable relative to the handle housing 20c, in particular about the rotary axis 154c. Alternatively, it is also conceivable that the decoupling element 174c is fixedly connected to the handle housing 20c, in particular the handle housing base body 120c, and mounted such that is movable relative to the motor housing 24c, in particular about the rotary axis 154c.

1. A housing apparatus for a hand-held angle grinder, comprising:
at least one handle housing which comprises at least one bow handle;
at least one motor housing which comprises a storage area configured to receive in which a drive unit of the hand-held power tool and which specifies an orientation of an axis of rotation of the drive unit, wherein, viewed in a direction parallel to the axis of rotation, the bow handle is disposed on the motor housing at least substantially entirely on a side of the motor housing facing away from a gearbox housing connection region of the motor housing; and
at least one battery pack interface configured for placement of at least one battery pack which is disposed on the handle housing on a side of the handle housing facing away from the bow handle,
wherein, viewed along a direction perpendicular to the axis of rotation, the bow handle projects largely beyond the motor housing.

2. The housing apparatus according to claim 1, wherein a maximum spacing of the at least one bow handle relative to the axis of rotation is at least 80 mm viewed along the direction perpendicular to the axis of rotation.

3. The housing apparatus according to claim 1, wherein the at least one bow handle has a maximum handle length of at least 250 mm.

4. The housing apparatus according to claim 1, wherein the at least one bow handle comprises at least one gripping surface which faces the at least one handle housing and, viewed along the direction parallel to the axis of rotation, is spaced apart from the at least one motor housing and, viewed along the direction parallel to the axis of rotation, comprises at least two gripping surface portions which, viewed in the direction perpendicular to the axis of rotation, enclose an angle of at least 70°.

5. The housing apparatus according to claim 1, wherein a gripping surface portion of a gripping surface of the at least one bow handle encloses an angle with an axis which extends parallel to the axis of rotation which has a value between 40° and 50°.

6. The housing apparatus according to claim 1, wherein a gripping surface portion of a gripping surface of the at least one bow handle encloses an angle with the axis of rotation which has a value between 90° and 120°.

7. The housing apparatus according to claim 1, wherein:
the at least one bow handle comprises at least one control element which, viewed along a maximum handle length of the at least one bow handle, is disposed in a central region of the at least one bow handle; and
a value of a maximum longitudinal extension of the at least one control element is at least 20% of a value of the maximum handle length of the at least one bow handle.

8. The housing apparatus according to claim 1, wherein the at least one battery pack interface is disposed in the immediate vicinity of the axis of rotation.

9. The housing apparatus according to claim 1, wherein, on a side of the at least one battery pack interface facing away from the at least one motor housing, the at least one handle housing comprises a battery protection wall which has a maximum extension, starting from the axis of rotation and extending along a direction perpendicular to the axis of rotation, that corresponds to more than 25% of the maximum extension of the motor housing starting from the axis of rotation along the direction perpendicular to the axis of rotation.

10. The housing apparatus according to claim 1, wherein, for at least one cooling unit for cooling an interior space of the motor housing and/or for cooling an interior space of the handle housing, which is disposed on the at least one handle housing at least partly opposite to the at least one bow handle, the at least one handle housing comprises a cooling air inlet region which
faces the at least one bow handle and/or
is disposed at the ventilation openings of the cooling unit and/or
is disposed at least substantially entirely between the axis of rotation and the at least one bow handle.

11. A hand-held power, comprising:
the housing apparatus according to claim 1; and
a drive unit which comprises the axis of rotation.

12. The hand-held power tool according to claim 11, having a maximum hand-held power tool longitudinal extension, wherein:
a value of a maximum spacing of the at least one bow handle to the axis of rotation is at least 20% of a value of the maximum hand-held power tool longitudinal extension, at least viewed along a direction perpendicular to the axis of rotation.

13. The hand-held power tool according to claim 11, further comprising:
hand-held power tool electronics and at least one electrical connecting element configured to electrically connect the drive unit to the hand-held power tool electronics and/or the battery pack interface, wherein, at a pivot joint of the housing apparatus, by which the handle housing is movably mounted on the motor housing, the electrical connecting element has an excess length to make possible a rotation of the handle housing relative to the motor housing.

14. The hand-held power tool according to claim 11, wherein at least one battery pack interface for placement of at least one battery pack, which is disposed on the at least one handle housing on a side of the at least one handle housing facing away from the at least one bow handle, wherein the at least one battery pack interface is disposed in an immediate vicinity of the axis of rotation of the drive unit.

15. The hand-held power tool according to claim 11, having a hand-held power tool center of gravity, wherein the at least one battery pack interface is disposed in an immediate vicinity of the hand-held power tool center of gravity.

16. The hand-held power tool according to claim 11, wherein the hand-held power tool is an angle grinder.
